(19) United States
(12) Patent Application Publication
(10) Pub. No.: US 2018/0319241 A1
(43) Pub. Date: Nov. 8, 2018

(54) SUSPENSION CONTROL APPARATUS

(71) Applicant: HITACHI AUTOMOTIVE SYSTEMS, LTD., Ibaraki (JP)

(72) Inventors: Ryusuke HIRAO, Atsugi-shi, Kanagawa (JP); Nobuyuki ICHIMARU, Atsugi-shi, Kanagawa (JP)

(21) Appl. No.: 15/740,598

(22) PCT Filed: Jun. 15, 2016
(86) PCT No.: PCT/JP2016/067774

§ 371 Date: Dec. 28, 2017

(30) Foreign Application Priority Data
Jun. 30, 2015 (JP) 2015-131460

(51) Int. Cl. B60G 17/08; B60G 17/018; F16F 9/53

(52) U.S. Cl. CPC B60G 17/08; B60G 17/018; F16F 9/532; B60G 2202/24; B60Y 2400/3084; B60G 2400/5182; B60G 2400/7162; B60G 2400/98; B60G 2600/21; B60G 2400/102

(57) ABSTRACT

A suspension control apparatus that includes a vehicle behavior detection unit, a damping force adjustable shock absorber, and a controller. The damping force adjustable shock absorber includes a cylinder in which the electric rheological fluid is encapsulated, a piston, a piston rod extending to an outside of the cylinder, and an electrode configured to apply electric field to the electric rheological fluid. The controller includes a target voltage value setting unit configured to obtain a target voltage value to be applied to the electrode based on the detection result obtained by the vehicle behavior detection unit, a current detection unit configured to detect a current value exhibited when the target voltage value obtained by the target voltage value setting unit is applied, and a voltage value correction unit configured to correct the target voltage value based on the detected current value or a function of the detected current value.

### TECHNICAL FIELD

The present invention relates to a suspension control apparatus to be installed in a vehicle, for example, a motor vehicle.

### BACKGROUND ART

In general, in a vehicle, for example, a motor vehicle, a shock absorber (damper) is provided between a vehicle body (sprung) side and each wheel (unsprung) side. In Patent Literature 1, there is described a technology relating to a damping force adjustable shock absorber, for estimating the temperature of a solenoid of a proportional solenoid valve based on a current flowing through the solenoid, and correcting the current supplied to the solenoid in accordance with the estimated temperature. In Patent Literature 2, there is described a technology relating to a shock absorber using electric rheological fluid, for estimating the temperature of the electric rheological fluid serving as working fluid based on an electrostatic capacity of the electric rheological fluid.

### CITATION LIST

### Patent Literature

PTL 1: JP H10-119529 A

PTL 2: JP H10-2368 A

### SUMMARY OF INVENTION

### Technical Problem

In the configuration described in Patent Literature 1, the temperature of the solenoid of the damping force adjustable shock absorber is estimated, and hence a difference may occur between the estimated temperature and the temperature of the working fluid in the shock absorber. Therefore, when the technology described in Patent Literature 1 is applied to, for example, a shock absorber using, as working fluid, electric rheological fluid having a great change in its characteristic (change in viscosity) caused by a temperature change, a change in damping force characteristic caused by the temperature change may not sufficiently be handled. Meanwhile, with the configuration described in Patent Literature 2, the temperature of the electric rheological fluid in the shock absorber can be estimated, but a circuit configured to measure the electrostatic capacity of the electric rheological fluid is required. Thus, there is a fear for an increase in complexity of an apparatus.

The present invention has an object to provide a suspension control apparatus capable of suppressing a change in damping force characteristic (characteristic change in damping force adjustable shock absorber) caused by a temperature change in electric rheological fluid.

### Solution to Problem

In order to solve the above-mentioned problems, according to one embodiment of the present invention, there is provided a suspension control apparatus including: a vehicle behavior detection unit configured to detect a behavior of a vehicle; a damping force adjustable shock absorber provided between two members of the vehicle, which are configured to move relative to each other; and a controller configured to carry out control so as to adjust a damping force of the damping force adjustable shock absorber based on a detection result obtained by the vehicle behavior detection unit. The damping force adjustable shock absorber includes: a cylinder in which electric rheological fluid is encapsulated; a piston slidably inserted into the cylinder; a piston rod coupled to the piston and extending to an outside of the cylinder; and an electrode provided at a portion through which a flow of the electric rheological fluid is to be generated by a slide motion of the piston in the cylinder, and configured to apply electric field to the electric rheological fluid. The controller includes: a target voltage value setting unit configured to obtain a target voltage value to be applied to the electrode based on the detection result obtained by the vehicle behavior detection unit; a current detection unit configured to detect a current value exhibited when the target voltage value obtained by the target voltage value setting unit is applied; and a voltage value correction unit configured to correct the target voltage value based on the detected current value detected by the current detection unit or a function of the detected current value.

According to the suspension control apparatus of the one embodiment of the present invention, it is possible to suppress a change in damping force characteristic (characteristic change in damping force adjustable shock absorber) caused by the temperature change in electric rheological fluid.

### BRIEF DESCRIPTION OF DRAWINGS

FIG. 1 is a schematic diagram for illustrating a suspension control apparatus according to a first embodiment.

FIG. 2 is a block diagram for illustrating a high voltage driver of FIG. 1.

FIG. 3 is a block diagram for illustrating a controller of FIG. 1.

FIG. 4 is a block diagram for illustrating a temperature estimation section of FIG. 3.

FIG. 5 is a characteristic diagram for showing a relationship between a high voltage value, a resistance, and a temperature.

FIG. 6 is characteristic diagrams for showing sprung acceleration power spectrum densities (PSDs) of a floor of a driver's seat, a shock absorber on a vehicle front side, and a shock absorber on a vehicle rear side.

FIG. 7 is characteristic diagrams for showing an example of temporal changes in a sprung behavior.

FIG. 8 is characteristic diagrams for showing an example of temporal changes in high voltage command values.

FIG. 9 is a block diagram for illustrating a temperature estimation section according to a second embodiment.

FIG. 10 is a characteristic diagram for showing a relationship between the high voltage value, a power, and the temperature.

FIG. 11 is a block diagram for illustrating a temperature estimation section according to a third embodiment.

FIG. 12 is a schematic diagram for illustrating a suspension control apparatus according to a fourth embodiment.

FIG. 13 is a block diagram for illustrating a high voltage driver of FIG. 12.

FIG. 14 is a block diagram for illustrating a controller of FIG. 12.

FIG. 15 is a block diagram for illustrating a temperature estimation section of FIG. 14.

FIG. 16 is a block diagram for illustrating a temperature estimation section according to a fifth embodiment.

FIG. 17 is a block diagram for illustrating a temperature estimation section according to a sixth embodiment.

FIG. 18 is a schematic diagram for illustrating a suspension control apparatus according to a seventh embodiment.

FIG. 19 is a block diagram for illustrating a controller of FIG. 18.

FIG. 20 is a block diagram for illustrating a vehicle state estimation section of FIG. 19.

FIG. 21 is a block diagram for illustrating a controller according to an eighth embodiment.

FIG. 22 is a block diagram for illustrating a temperature estimation section of FIG. 21.

### DESCRIPTION OF EMBODIMENTS

With reference to the accompanying drawings, a description is now given of a suspension control apparatus according to each embodiment while exemplifying a case in which this suspension control apparatus is mounted to a four-wheel vehicle.

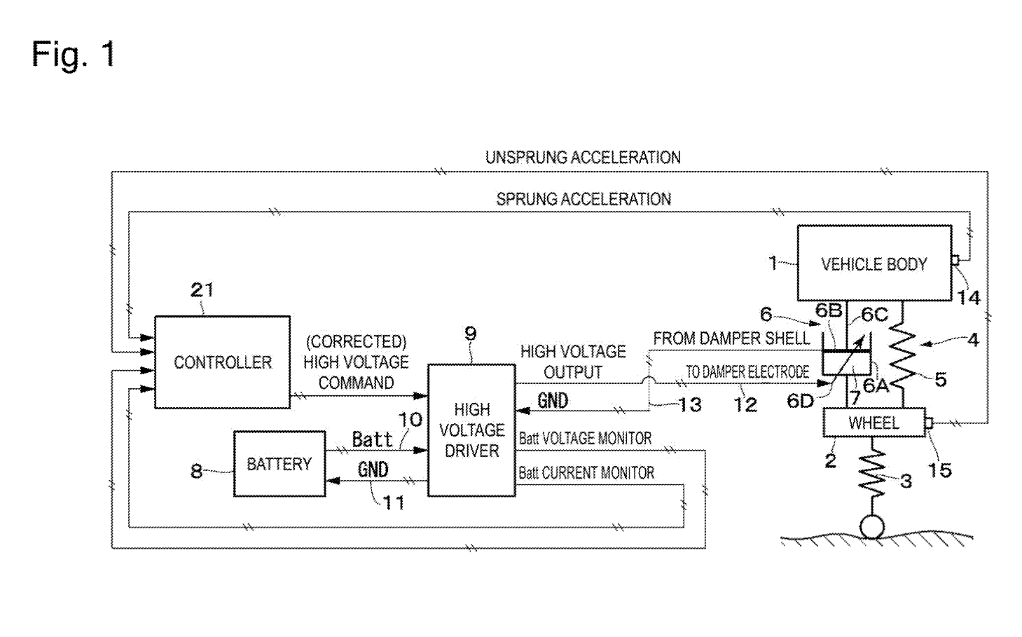

FIG. 1 to FIG. 5 are diagrams for illustrating a first embodiment. In FIG. 1, a vehicle body 1 constructs a body of the vehicle. On a bottom side of the vehicle body 1, wheels constructing the vehicle together with the vehicle body 1, for example, left and right front wheels and left and right rear wheels (hereinafter collectively referred to as wheels 2), are provided. The wheel 2 includes a tire 3, and the tire 3 serves as a spring configured to absorb small recesses and protrusions on a road surface.

The suspension apparatus 4 is interposed between the vehicle body 1 and the wheel 2, which construct two members of the vehicle configured to move relative to each other. The suspension apparatus 4 includes a suspension spring 5 (hereinafter referred to as spring 5), and a damping force adjustable shock absorber (hereinafter referred to as shock absorber 6) provided in parallel with the spring 5 between two members, namely, between the vehicle body 1 and the wheel 2. In FIG. 1, a case in which one set of suspension apparatus 4 is provided between the vehicle body 1 and the wheel 2 is exemplified. However, for example, a total of four sets of suspension apparatus 4 are individually and independently provided between the four wheels 2 and the vehicle body 1, and only one set of the suspension apparatus 4 is schematically illustrated in FIG. 1.

The shock absorber 6 of the suspension apparatus 4 is configured to damp a vertical movement of the wheel 2, and is constructed as a damping force adjustable shock absorber that uses electric rheological fluid 7 as hydraulic oil (working fluid). In other words, the shock absorber 6 includes a cylinder 6A in which electric rheological fluid 7 is encapsulated, a piston 6B slidably inserted into the cylinder 6A, a piston rod 6C coupled to the piston 6B, and extending to the outside of the cylinder 6A, and an electrode 6D provided at a portion through which a flow of the electric rheological fluid 7 is generated by the slide of the piston 6B in the cylinder 6A, and configured to apply electric field to the electric rheological fluid 7.

The electric rheological fluid (ERF) 7 is formed from, for example, base oil formed of silicon oil or the like, and particles (particulates), which are mixed with the base oil (dispersed), and changes its viscosity (degree of viscosity) in accordance with a change in electric field. As a result, a flow resistance (damping force) of the electric rheological fluid 7 changes in accordance with the applied voltage. In other words, the shock absorber 6 is capable of continuously adjusting a characteristic (damping force characteristic) of a generated damping force from a hard characteristic to a soft characteristic, in accordance with the voltage applied to the electrode 6D provided at the portion through which the flow of the electric rheological fluid 7 is generated. The shock absorber 6 may adjust the damping force characteristic not continuously but in two stages or a plurality of stages.

The battery 8 serves as a power supply for applying voltage to the electrode 6D of the shock absorber 6, and is constructed of, for example, a 12 V in-vehicle battery serving as an accessory battery for the vehicle (and an alternator configured to charge the in-vehicle battery depending on necessity). The battery 8 is connected to the shock absorber 6 (the electrode 6D and the cylinder 6A serving as a damper shell) via a high voltage driver 9 including a booster circuit 9A. For example, in a case of a hybrid vehicle or an electric vehicle in which an electric motor (drive motor) for traveling is installed, a high capacity battery (not shown) for driving the vehicle may be used as a power supply for the shock absorber 6.

The high voltage driver 9 generates a high voltage to be applied to the electric rheological fluid 7 of the shock absorber 6. The high voltage driver 9 is therefore connected to the battery 8 serving as the power supply via a battery line (batt line) 10 and a ground line (GND line) 11 constructing (low voltage) DC power lines. Simultaneously, the high voltage driver 9 is connected to the shock absorber 6 (the electrode 6D and the cylinder 6A serving as the damper shell) via a high voltage output line 12 and a ground line (GND line) 13 constructing (high voltage) DC power lines.

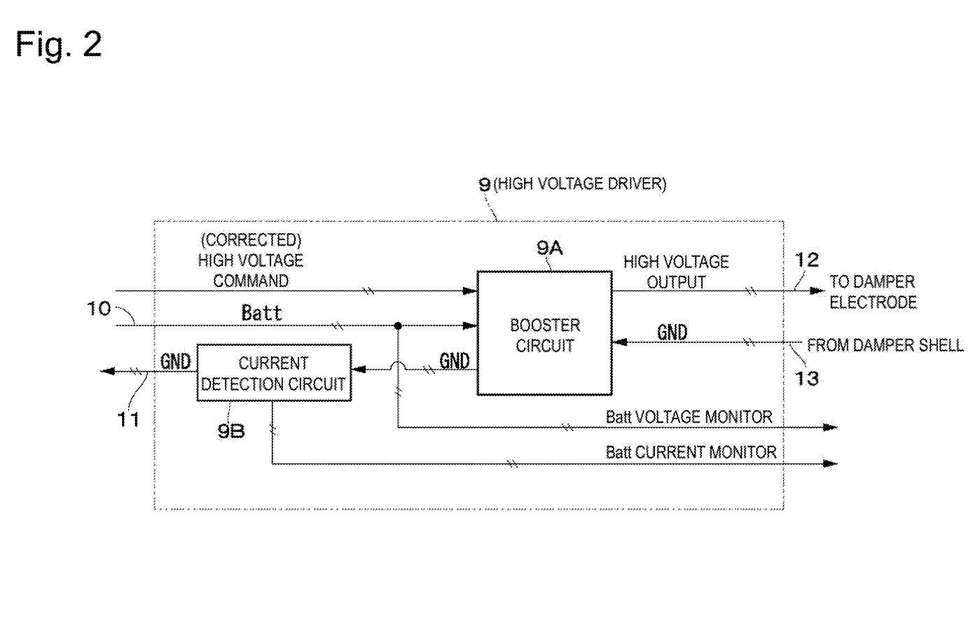

The high voltage driver 9 boosts the DC voltage output from the battery 8 based on commands (high voltage command and corrected high voltage command) output from the controller 21, and supplies (outputs) the boosted DC voltage to the shock absorber 6. As illustrated in FIG. 2, the high voltage driver 9 includes the booster circuit 9A configured to boost the DC voltage of the battery 8 and a current detection circuit 9B configured to detect a battery current. The high voltage driver 9 uses the booster circuit 9A to control the voltage output to the shock absorber 6 in accordance with the commands input from the controller 21.

The current detection circuit 9B is provided between the booster circuit 9A and the battery 8 (on the ground line 11 side). The current detection circuit 9B detects a current value before being boosted, and outputs a current monitor signal, which represents the current value, as a battery current monitor value (batt current monitor value, power supply current monitor value, battery current value, or power supply current value) to the controller 21. Further, the high voltage driver 9 monitors the voltage supplied from the battery 8, and outputs a monitor signal of the voltage as a battery voltage monitor value (batt voltage monitor value, power supply voltage monitor value, battery voltage value, or power supply voltage value) to the controller 21. In the first embodiment, the controller 21 is configured to use the monitor signals of the low voltage system of 12 V on the in-vehicle battery side to carry-out temperature estimation and control described later.

A sprung acceleration sensor 14 is provided on the vehicle body 1 side. Specifically, the sprung acceleration-sensor 14 is mounted to the vehicle body 1 at, for example, a position close to the shock absorber 6. The sprung acceleration sensor 14 detects a vibration acceleration in a vertical direction on the vehicle body 1 side, which is a so-called sprung side, and outputs the obtained detection signal to the controller 21 described later.

An unsprung acceleration sensor 15 is provided on the wheel 2 side of the vehicle. The unsprung acceleration sensor 15 detects a vibration acceleration in the vertical direction on the wheel 2 side, which is a so-called unsprung side, and outputs the obtained detection signal to the controller 21 described later. In this case, the sprung acceleration sensor 14 and the unsprung acceleration sensor 15 constructs a vehicle behavior detection unit (more specifically, a vertical motion detection unit) configured to defect a behavior of the vehicle (more specifically, a state relating to a motion in the vertical direction of the vehicle).

The vehicle behavior detection unit is not limited to the sprung acceleration sensor 14 and the unsprung acceleration sensor 15 provided near the shock absorber 6, and may include, for example, only the sprung acceleration sensor 14, or a vehicle height sensor (not shown). Further, the vehicle behavior detection unit may include a vehicle behavior detection sensor configured to detect a behavior (state quantity) of the vehicle other than the acceleration sensors 14 and 15 and the vehicle height sensor, for example, a wheel speed sensor (not shown) configured to detect a rotation speed of the wheel 2. In this case, for example, the vertical motion of the vehicle may be detected by estimating the vertical motion of each of the wheels 2 from the information (acceleration) obtained by one sprung acceleration sensor 14 and the information (wheel speed) obtained by the wheel speed sensor.

The controller 21 is constructed of, for example, a microcomputer, and carries out control of adjusting the damping force of the shock absorber 6 based on the detection results obtained by the sprung acceleration sensor 14 and the unsprung acceleration sensor 15. In other words, the controller 21 calculates, based on calculation processing described later, the command to be output to (the booster circuit 9A of) the high voltage driver 9, namely, the (corrected) high voltage command, from the information acquired from the sprung acceleration sensor 14 and the unsprung acceleration sensor 15 to thereby control the shock absorber 6, which is the variable-damping-force damper.

The controller 21 receives input of the Batt voltage monitor signal and the Batt current monitor signal which are output from the high voltage driver 9 in addition to the sprang acceleration signal output from the sprung acceleration sensor 14 and the unsprung acceleration signal output from the unsprung acceleration sensor 15. The Batt voltage monitor signal is a signal representing the monitored Batt voltage value applied to the high voltage driver 9. The Batt current monitor signal is a signal representing the monitored Batt current consumed by the high voltage driver 9.

The controller 21 calculates the (corrected) high voltage command corresponding to the force (damping force) to be output in the shock absorber 6, based on the sprung acceleration signal and the unsprung acceleration signal serving as the behavior information (vehicle behavior signal) on the vehicle and based on the Batt voltage monitor signal and the Batt current monitor signal serving as power information (shock absorber power signal) on the shock absorber 6, and outputs the calculated (corrected) high voltage command to the high voltage driver 9. The high voltage driver 9 outputs, based on the (corrected) high voltage command from the controller 21, a high voltage corresponding to the command to the electrode 6D of the shock absorber 6. In the shock absorber 6, which receives the input of the high voltage, the viscosity of the electric rheological fluid 7 changes in accordance with a change in voltage value (potential difference between the electrode 6D and the cylinder 6A), thereby being capable of switching (adjusting) the damping force characteristic of the shock absorber 6.

Incidentally, a conventional suspension apparatus (semi-active suspension) configured to switch the damping force through a hydraulic valve uses mineral oil as base oil of working fluid, and has a small performance change of the shock absorber caused by the temperature. In other words, even when the temperature of the working fluid changes, the change in vehicle performance is small. In contrast, the base oil of the electric rheological fluid 7 is silicon oil, and has a larger viscosity change in accordance with the temperature than that of the mineral oil. Specifically, the electric rheological fluid 7 exhibits high viscosity (an increased damping force) at a low temperature, and exhibits low viscosity (a decreased damping force) at a high temperature.

As a result, when the same control as that in the mineral oil-based suspension apparatus is carried out in the suspension apparatus using the silicon oil-based electric rheological fluid 7 as the working fluid, the performance may change in accordance with the temperature. In other words, the damping force at a low temperature may be larger than a damping force intended at the design stage, resulting in excessive control, and the damping force at a high temperature may be smaller than a damping force intended at the design stage, resulting in insufficient control. Moreover, responsiveness to the command of the electric rheological fluid 7 also changes in accordance with the temperature. Specifically, the responsiveness decreases at a low temperature, and the responsiveness increases at a high temperature. When the responsiveness increases, a potential of abnormal noise occurrence degrades, and hence the abnormal noise is liable to be generated.

In contrast, in order to suppress those inconveniences (performance change, damping force change, and responsiveness change), it is conceivable to correct (adjust) the control for the shock absorber 6 in accordance with the temperature of the electric rheological fluid 7. In Patent Literature 1, there is described a technology relating to a shock absorber of an adjustable damping force type, for estimating the temperature of a solenoid of a proportional solenoid valve based on a current flowing through the solenoid, and correcting the current supplied to the solenoid in accordance with the estimated temperature.

However, in the case of this technology, a difference between the estimated temperature of the solenoid and the temperature of the working fluid in the shock absorber may be generated. For example, on a rough road causing a high input to the shock absorber, the temperature of the working fluid quickly increases, and this increase in heat is transferred to the solenoid via the piston or the piston rod of the shock absorber. Therefore, the delay in the heat transfer causes the generation of the difference between the estimated temperature and the actual temperature of the working fluid, and the control performance may decrease due to this difference. Meanwhile, in Patent Literature 2, there is described a technology for estimating the temperature of the electric rheological fluid based on an electrostatic capacity of the electric rheological fluid. However, this technology requires a circuit configured to measure the electrostatic capacity of the electric rheological fluid, and hence there is a fear for an increase in complexity of the apparatus.

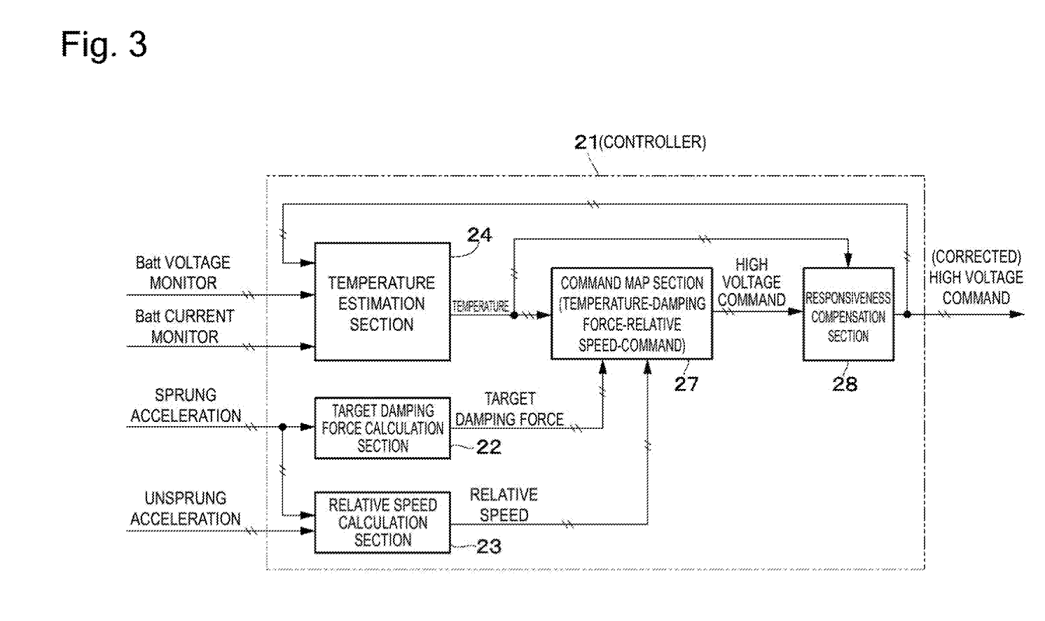

Meanwhile, the inventors of the present invention have found that the electric resistance value of the electric rheological fluid 7 itself changes in accordance with the temperature. Thus, in the embodiment, the controller 21 is configured to estimate the temperature of the electric rheological fluid 7 in accordance with the resistance value of the electric rheological fluid 7. As a result, in the embodiment, it is possible to increase an estimation accuracy of the temperature of the electric rheological fluid 7, to thereby suppress the change (performance decrease) in performance of the suspension apparatus 4 due to the temperature change. Now, with reference to FIG. 3 to FIG. 5 in addition to FIG. 1 and FIG. 2, the controller 21 according to the embodiment is described.

As illustrated in FIG. 3, the controller 21 includes a target damping force calculation section 22, a relative speed calculation section 23, a temperature estimation section 24, a command map section 27, and a responsiveness compensation section 28. The target damping force calculation section 22 integrates the detection signal (namely, the sprung acceleration) from the sprung acceleration sensor 14, to thereby calculate and estimate a displacement speed in the vertical direction of the vehicle body 1 as a sprung speed.

Further, the target damping force calculation section 22 multiplies this sprung speed by, for example, a skyhook damping coefficient obtained through the skyhook control theory, to thereby calculate a target damping force to be generated in the shock absorber 6. The control rule for calculating the target damping force is not limited to the skyhook control and feedback control, for example, the optimal control or H∞ control, can be used. The target damping force calculated by the target damping force calculation section 22 is output to the command map section 27.

The relative speed calculation section 23 calculates a relative acceleration in the vertical direction between the vehicle body 1 and the wheel 2 from the difference between the detection signal (namely, the unsprung acceleration) obtained by the unsprung acceleration sensor 15 and the detection signal (namely, the sprung acceleration) obtained by the sprung acceleration sensor 14, and integrates this relative acceleration, to thereby calculate a relative speed in the vertical direction between the vehicle body 1 and the wheel 2. The relative speed calculated by the relative speed calculation section 23 is output to the command map section 27.

The temperature estimation section 24 calculates (estimates) the temperature of the electric rheological fluid 7. To this end, the Batt voltage monitor signal and the Batt current monitor signal which are output from the high voltage driver 9 and a corrected high voltage command signal output from the responsiveness compensation section 28 of the controller 21 to the high voltage driver 9 are input to the temperature estimation section 24. The responsiveness compensation section 28 may be omitted (may not be provided). In this case, in place of the corrected high voltage command signal, a high voltage command signal output from the command map section 27 may be input to the temperature estimation section 24.

The temperature estimation section 24 calculates (estimates) the temperature of the electric rheological fluid 7 based on the Batt voltage monitor signal (namely, the battery voltage monitor value), the Batt current monitor signal (namely, the battery current monitor value), and the corrected high voltage command signal (namely, a corrected high voltage command value), and outputs the temperature (estimated temperature) to the command map section 27 and the responsiveness compensation section 28. When the responsiveness compensation section 28 is omitted, in place of the corrected high voltage command signal, the high voltage command signal (namely, a high voltage command value) may be used to calculate (estimate) the temperature, and the temperature (estimated temperature) may be output to the command map section 27.

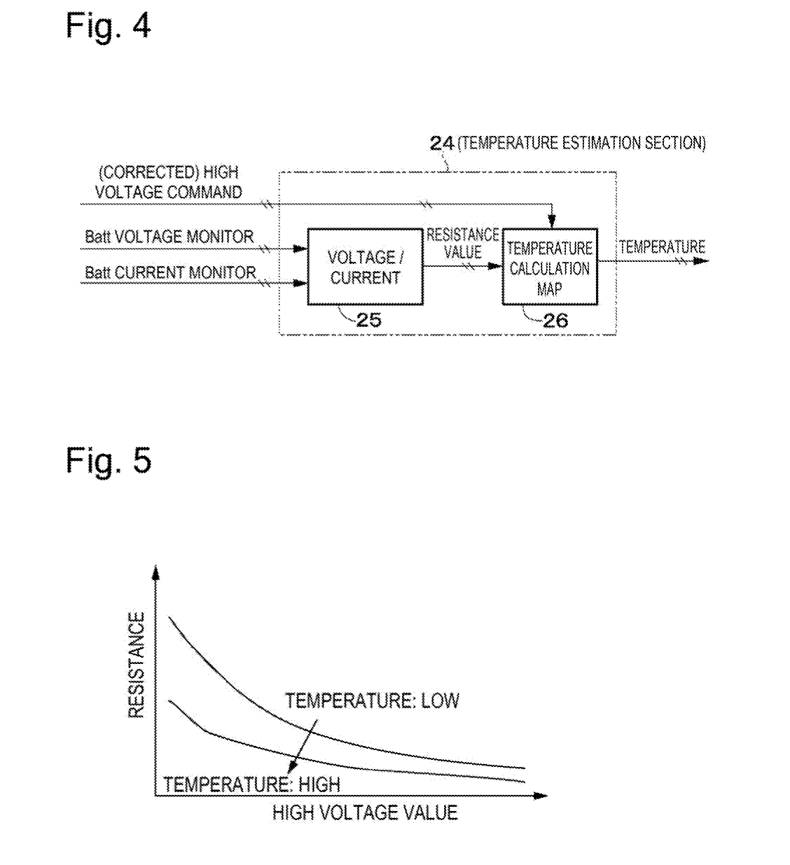

As illustrated in FIG. 4, the temperature estimation section 24 includes a resistance value calculation section 25 and a temperature calculation map section 26. The resistance value calculation section 25 calculates the resistance value of the electric rheological fluid 7 based on the battery voltage monitor value and the battery current monitor value which are output from the high voltage driver 9. Specifically, the resistance value of the electric rheological fluid 7 is calculated by dividing the battery voltage monitor value by the battery current monitor value. The resistance value calculated by the resistance value calculation section 25 is output to the temperature calculation map section 26.

The temperature calculation map section 26 estimates the temperature of the electric rheological fluid 7 from the resistance value of the electric rheological fluid 7 calculated by the resistance value calculation section 25 and the corrected high voltage command value output from the responsiveness compensation section 28, based on, for example, a temperature calculation map shown in FIG. 5. When the responsiveness compensation section 28 is omitted, the high voltage command value may be used in place of the corrected high voltage command value. In the temperature calculation map section 26, a high voltage value of the temperature calculation map of FIG. 5 is set to the corrected high voltage command value or the high voltage command value to estimate the temperature of the electric rheological fluid 7.

The electric resistance value of the electric rheological fluid 7 changes in accordance with the temperature. Thus, in the temperature calculation map section 26, a relationship (characteristic) between the “resistance value” of the electric rheological fluid 7, the “temperature”, and the applied “high voltage value”, which is obtained in advance through experiments, simulation, or the like, is set (stored) as, for example, the temperature calculation map of FIG. 5. The reason for the use of the high voltage value is to consider a change in resistance value in accordance with a change in high voltage value. As shown in FIG. 5, the resistance value of the electric rheological fluid 7 changes in accordance with the high voltage value and the temperature, and hence the temperature of the electric rheological fluid 7 is calculated based on this relationship.

The temperature calculation map section 26 uses the temperature calculation map shown in FIG. 5 to calculate (estimate) the temperature of the electric rheological fluid 7 from the resistance value and the high voltage value (corrected high voltage command value or high voltage command value) at the moment. The temperature calculated by the temperature calculation map section 26 is output to the command map section 27 and the responsiveness compensation section 28. In the embodiment, the map corresponding to the relationship (characteristic) between the resistance value and the temperature of the electric rheological fluid 7, and the applied high voltage value is used to estimate (calculate) the temperature, but the representation of the relationship is not limited to the map. For example, a calculation expression (function) or an array corresponding to the relationship between the resistance value, the temperature, and the high voltage value may be used.

Moreover, in the embodiment as the high voltage value used to estimate the temperature, namely, the high voltage value applied to the electric rheological fluid 7, the command value (the corrected high voltage command value or the high voltage command value) for the high voltage, which is output from the controller 21 to the high voltage driver 9, is used. However, the command value may be different (deviate) from the high voltage value actually applied to the electric rheological fluid 7. Therefore, as the high voltage value used to estimate the temperature, in place of the command value, an actual high voltage value may be used. Specifically, the high voltage of the high voltage output line 12 may be monitored, and a monitor signal (high voltage monitor value or high voltage value) of the high voltage may be input to (the temperature calculation map section 26 of) the controller 21.

The target damping force, the relative speed, and the temperature of the electric rheological fluid 7 are input to the command map section 27. The command map section 27 uses a command map to calculate the high voltage command value serving as the command voltage from the target damping force, the relative speed, and the temperature of the electric rheological fluid 7. The command map section 27 includes the command map corresponding to a characteristic (relationship) between the relative speed, the target damping force, the temperature, and the high voltage command value to be applied. The command map is obtained through experiments, simulation, or the like in advance as a map corresponding to the relationship (characteristic) between the target damping force, the relative speed, the temperature, and the command voltage to be applied, and is set to (stored in) the command map section 27.

In this way, the command map section 27 calculates the high voltage command value serving as the command voltage additionally in consideration of the temperature of the electric rheological fluid 7 at the moment. As a result, the high voltage command value calculated by the command map section 27 may be a value corresponding to the temperature of the electric rheological fluid 7 at the moment. Thus, the damping force actually generated in the shock absorber 6 may approach a reference damping force generated at a reference temperature (for example, 20° C. serving as a standard temperature) of the electric rheological fluid 7 regardless of the temperature of the electric rheological fluid 7 (whether the temperature is high or low). Conversely, when the command value not reflecting the temperature is set to the target voltage value, the command map section 27 can calculate the high voltage command value as a corrected target voltage value corrected from the target voltage value so as to approach the reference damping force. In the embodiment, the map is used to calculate the high voltage command value, but the representation of the relationship is not limited to the map. For example, a calculation expression (function) or an array corresponding to the relationship (characteristic) between the target damping force, the relative speed, the temperature, and the command voltage may be used.

The high voltage command value calculated by the command map section 27 is output to the responsiveness compensation section 28. The responsiveness compensation section 28 corrects the high voltage command value output from the command map section 27 based on the temperature output from the temperature estimation section 24. In other words, if the temperature is high, the viscosity of the electric rheological fluid 7 changes quickly when the high voltage command value changes, and switching responsiveness is thus high. In contrast, if the temperature is low, the viscosity of the electric rheological fluid 7 changes slowly when the high voltage command value changes, and the switching responsiveness is thus low. Thus, the responsiveness condensation section 28 corrects the high voltage command value output from the command map section 27 through responsiveness compensation corresponding to the temperature at the moment, to thereby calculate the corrected high voltage command value.

Specifically, the responsiveness compensation section 28 increases a limitation imposed on the switching speed (for example, increases the limitation imposed on a change speed of the high voltage command value) when the temperature is high, and decreases the limitation imposed on the switching speed (for example, decreases the limitation imposed on the change speed of the high voltage command value) when the temperature is low. The corrected high voltage command value calculated by the responsiveness compensation section 28 is output to the high voltage driver 9. The high voltage driver 9 outputs the high voltage corresponding to the corrected high voltage command value to the electrode 6D of the shock absorber 6. As a result, the shock absorber 6 can generate the damping force based on the viscosity of the electric rheological fluid 7 to which this high voltage is applied. As another responsiveness compensation method, the switching responsiveness of the damping force in accordance with the temperature may be stored in advance, and the high voltage command may be corrected in accordance with the responsiveness so as to reflect a characteristic opposite to this responsiveness in the high voltage command.

In this way, in the embodiment, the responsiveness compensation section 28 imposes the limitation on the change in voltage command in accordance with the temperature, to thereby calculate the final voltage command value (corrected high voltage command value). Then, the controller 21 outputs the final voltage command value (corrected high voltage command value) from the responsiveness compensation section 28 to the high voltage driver 9, to thereby switch the damping force of the shock absorber 6. As a result, also in this respect, the damping force generated in the shock absorber 6 can be brought to be close to the reference damping force generated at the reference temperature of the electric rheological fluid 7 regardless of the temperature of the electric rheological fluid 7 (whether the temperature is high or low).

In the embodiment, the target damping force is used as the control command, but a target damping coefficient may be used instead. Moreover, the responsiveness compensation section may be omitted. In this case, the high voltage command value output from the command map section 27 may be output to the high voltage driver 9 (and the temperature estimation section 24).

In any case, in the embodiment, the controller 21 includes a target voltage value setting unit, a current detection unit, and a voltage value correction unit. The target voltage value setting unit is configured to obtain the target voltage value (high voltage command value) to be applied to the electrode 6D of the shock absorber 6 based on the detection results obtained by the vehicle behavior detection unit (sprung acceleration sensor 14 and unsprung acceleration sensor 15). The target voltage value setting unit corresponds to, for example, the target damping force calculation section 22, the relative speed calculation section 23, and the command map section 27.

The current detection unit is configured to detect the current value exhibited when the target voltage value (high voltage command value or the corrected high voltage command value) obtained by the target voltage value setting unit is applied. The current detection unit corresponds to, for example, the configuration of inputting the battery current monitor value output from the current detection circuit 9B of the high voltage driver 9 to the temperature estimation section 24 of the controller 21.

The voltage value correction unit is configured to correct the target voltage value based on the detected current value (battery current monitor value) detected by the current detection unit. The voltage value correction unit corresponds to, for example, the temperature estimation section 24, the command map section 27, and the responsiveness compensation section 28.

(The temperature estimation section 24 of) the voltage value correction unit includes a resistance value calculation unit and a temperature estimation unit. The resistance value calculation unit is configured to obtain the resistance value of the electric rheological fluid 7 from the detected current value (battery current monitor value) detected by the current detection unit and the battery voltage monitor value. The resistance value calculation unit corresponds to, for example, the resistance value calculation section 25 of the temperature estimation unit 24. The temperature estimation unit is configured to estimate the temperature of the electric rheological fluid 7 from the resistance value calculated by the resistance value calculation unit (resistance value calculation section 25). The temperature estimation unit corresponds to, for example, the temperature calculation map section 26 of the temperature estimation section 24.

Then, (the command map section 27 and, depending on necessity, the responsiveness compensation section 28, of) the voltage value correction unit uses the temperature estimated by (the temperature calculation map section 26 of) the temperature estimation unit as a function of the detected current value, to thereby correct the target voltage value. Specifically, the command map section 27 calculates the high voltage command value in consideration of the temperature, and the responsiveness compensation section 28 calculates the corrected high voltage command value (correct the high voltage command value) in consideration of the temperature. In this case, (the command map section 27 and, depending on necessity, the responsiveness compensation section 28, of) the voltage value correction unit corrects the target voltage value so that the damping force actually generated by the electric rheological fluid 7 approaches the reference damping force generated at the reference temperature of the electric rheological fluid 7.

The suspension control apparatus according to the embodiment has the above-mentioned configurations. A description is now given of processing of using the controller 21 to variably control the damping force characteristic of the shock absorber 6.

The controller 21 receives the input of the detection signal corresponding to the sprung acceleration from the sprung acceleration sensor 14 during the travel of the vehicle, and simultaneously receives the input of the detection signal corresponding to the unsprung acceleration from the unsprung acceleration sensor 15. The target damping force calculation section 22 of the controller 21 integrates the sprung acceleration, to thereby calculate the sprung speed, and multiplies the sprung speed by the skyhook damping coefficient, to thereby calculate the target damping force to be generated in the shock absorber 6. Meanwhile, the relative speed calculation section 23 of the controller 21 subtracts the unsprung acceleration from the sprang acceleration, to thereby calculate the relative acceleration, and integrates the relative acceleration, to thereby calculate the relative speed between fee vehicle body 1 and the wheel 2.

Further, the controller 21 receives the input of the battery voltage monitor value and the battery current monitor value from the high voltage driver 9. The temperature estimation section 24 of the controller 21 calculates the temperature of the electric rheological fluid 7 based on the battery voltage monitor value, the battery current monitor value, and the corrected high voltage command value output to the high voltage driver 9. Specifically, the resistance value calculation section 25 of the temperature estimation section 24 calculates the resistance value of the electric rheological fluid 7 from the battery voltage monitor value and the battery current monitor value. The temperature calculation map section 26 of the temperature estimation section 24 calculates the temperature of the electric rheological fluid 7 from the resistance value and the high voltage value (corrected high voltage command value) based on the relationship (characteristic) between the resistance value, the high voltage value, and the temperature, which is obtained in advance.

Then, the command map section 27 of the controller 21 uses the command map to calculate the high voltage command value corresponding to the voltage (high voltage) to be output from the high voltage driver 9, from the target damping force, the relative speed, and the temperature of the electric rheological fluid 7 at the moment. Further, the responsiveness compensation section 28 of the controller 21 corrects (limits) the high voltage command value in accordance with the temperature of the electric rheological fluid 7 at the moment in order to compensate for the difference in the responsiveness caused by the temperature, and outputs the corrected high voltage command value to the high voltage driver 9. The high voltage driver 9 applies (outputs to the electrode 6D of the shock absorber 6) the voltage (high voltage) corresponding to the corrected high voltage command value to the electric rheological fluid 7, to thereby control the viscosity of the electric rheological fluid 7. As a result, the damping force characteristic of the shock absorber 6 becomes variable between the hard characteristic and the soft characteristic, and is continuously controlled.

The resistance value of the electric rheological fluid 7 changes in accordance with the temperature. Therefore, in the embodiment, the power (current and voltage) required when the voltage is applied is measured, to thereby estimate the temperature of the electric rheological fluid 7. More specifically, in the embodiment, the voltage value and the current value used to generate the high voltage applied to the electric rheological fluid 7 are measured (monitored), and the resistance value is calculated from the voltage value and the current value. Then, the temperature of the electric rheological fluid 7 is estimated from the calculated resistance value and the relationship between the temperature and the resistance value measured in advance in accordance with the temperature. In this case, the temperature of the electric rheological fluid 7 may be estimated through a state estimation that is carried out in consideration of heat generation and heat radiation (external temperature, water temperature, and vehicle speed) of the shock absorber 6.

In the embodiment, a damping force characteristic map (the command map of the command map section 27) for calculating the control command (high voltage command) is caused to have the temperature dependency, to thereby automatically adjust the control command in accordance with the change in damping force caused by the temperature change. As a result, the performance can be maintained regardless of the temperature of the electric rheological fluid 7 (whether the temperature is high or low). In tins case, the performance change caused by the temperature change is automatically corrected, but, for additional adaptability, for example, the temperature input to the map, the map, or a gain may be corrected. Moreover, the damping force (soft damping force and hard damping force) corresponding to a predetermined voltage changes in accordance with the temperature, and offset control for the voltage is thus changed in accordance with the temperature. Specifically, the voltage may be set to low at a low temperature, and the voltage may be set to high at a high temperature.

Moreover, the responsiveness of the viscosity change (change in damping force of the shock absorber 6) of the electric rheological fluid 7 decreases at a low temperature, and the responsiveness increases at a high temperature. Therefore, in the embodiment, the responsiveness compensation section 28 of the controller 21 sets a less strict limitation (weakens the limitation) to the change in damping force command at a low temperature, and sets a more strict limitation (strengthens the limitation) to the change at a high temperature. As a result, both suppression of a decrease in performance and a decrease in abnormal noise can simultaneously be provided. In other words, the responsiveness can also be compensated, and hence the decrease in responsiveness can be suppressed at a low temperature while the excess in the responsiveness can be suppressed at a high temperature. In this way, the occurrence of the abnormal noise can be suppressed.

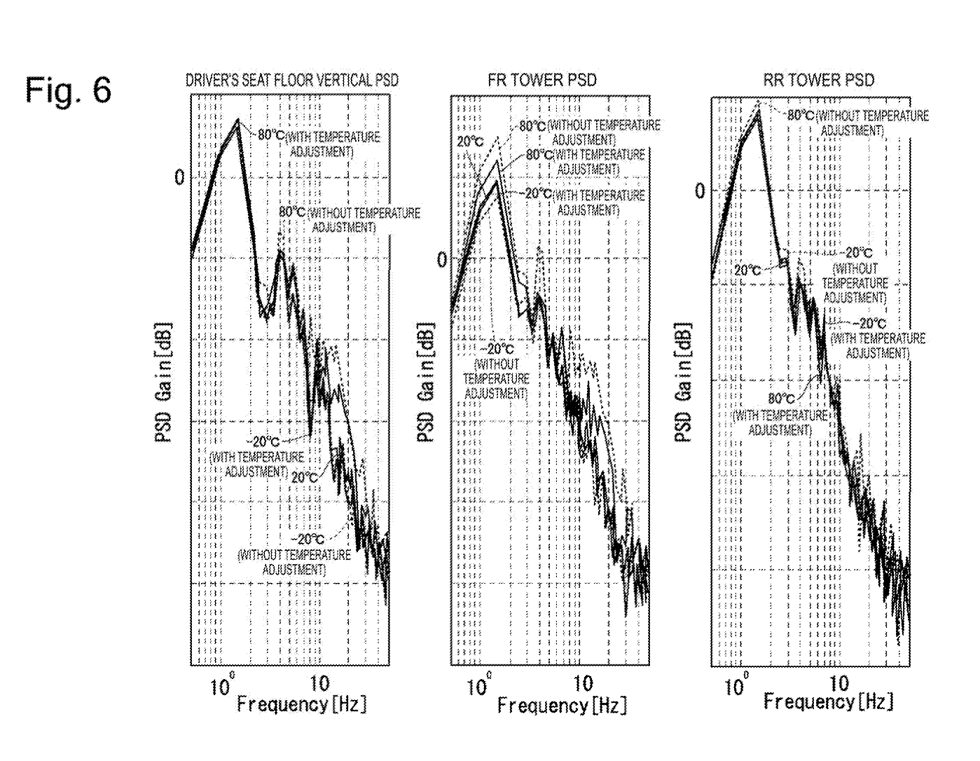

With reference to FIG. 6 to FIG. 8, a description is now given of verification of effects of the embodiment through simulation that was carried out to verify the effects.

In this verification, a vehicle to be controlled was assumed to be a large sedan (large passenger car), the change in damping force in accordance with the temperature of the electric rheological fluid 7 was assumed to be indicated as Table 1, and the simulation was carried out on an irregular road, which excited sprung vibration.

TABLE 1

| Temperature of electric rheological | Damping force ratio (damping |
|---|---|
| fluid [° C.] | force/damping force at 20° C.) |
| −20 | 0.5 |
| 20 | 1 |
| 80 | 1.5 |

FIG. 6 is diagrams for showing sprung acceleration power spectrum densities (PSDs) in the embodiment, in which the control command (high voltage command) was adjusted in accordance with the temperature, and in a comparative example, in which the control command was not adjusted. Three solid lines of FIG. 6 represent a reference case in which the temperature of the electric rheological fluid 7 was 20° C., a case in which the control command was adjusted in accordance with the temperature when the temperature of the electric rheological fluid 7 was 80° C., and a case in which the control command was adjusted in accordance with the temperature when the temperature of the electric rheological fluid 7 was −20° C. Meanwhile, two broken lines of FIG. 6 represent a case in which the control command was not adjusted when the temperature of the electric rheological fluid 7 was 80° C. and a case in which the control command was adjusted when the temperature of the electric rheological fluid 7 was −20° C.

As can be found from FIG. 6, the two broken lines representing the case in which the control command was not adjusted in accordance with the temperature greatly differ from the three solid lines (two solid lines representing the case in which the control command was adjusted in accordance with the temperature and the solid line representing the case in which the temperature of the electric rheological fluid 7 was 20° C.) particularly for FR tower PSDs (sprung accelerations of the shock absorber 6 on the front right side of the vehicle) (sprung acceleration PSDs represented by the broken lines in the cases in which the control was not adjusted in accordance with the temperature degrade). In contrast, the two solid lines representing the case in which the control command was adjusted in accordance with the temperature have smaller differences (smaller differences from the solid line at 20° C.) than the broken lines representing the case in which the control command was not adjusted in accordance with the temperature. Therefore, even when the temperature of the electric rheological fluid 7 is 80° C. or −20° C., the difference in performance from the case in which the temperature of the electric rheological fluid 7 is 20° C. can be decreased by adjusting the control command in accordance with the temperature.

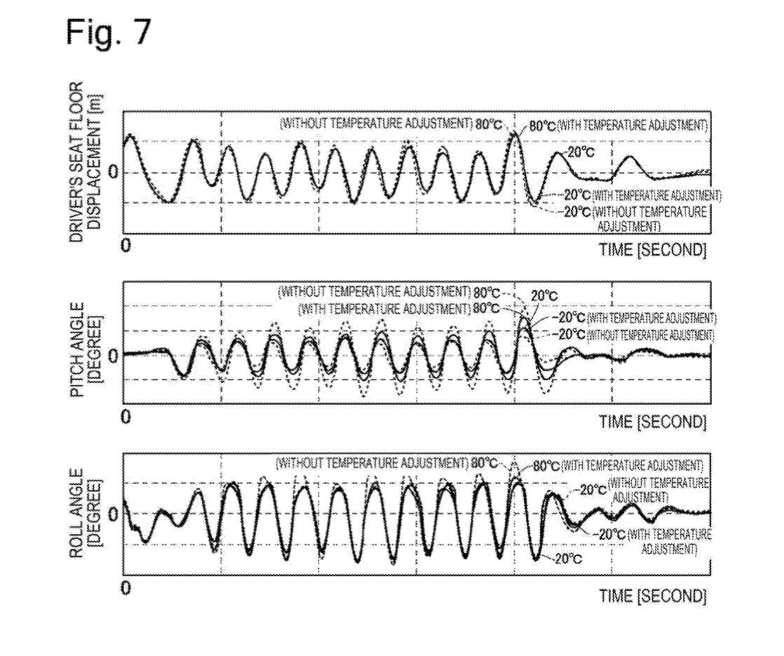

FIG. 7 is diagrams for showing temporal changes (time series data) in a sprung behavior of the embodiment, in which the control command (high voltage command) was adjusted in accordance with the temperature, and a comparative example, in which the control command was not adjusted. Also in FIG. 7, as in FIG. 6, three solid lines represent the reference case in which the temperature of the electric rheological fluid 7 was 20° C., the case in which the control command was adjusted in accordance with the temperature when the temperature of the electric rheological fluid 7 was 80° C., and the case in which the control command was adjusted in accordance with the temperature when the temperature of the electric rheological fluid 7 was −20° C., and two broken lines represent the case in which the control command was not adjusted when the temperature of the electric rheological fluid 7 was 80° C. and the case in which the control command was not adjusted when the temperature of the electric rheological fluid 7 was −20° C.

As can be found from FIG. 7, the two broken lines representing the case in which the control command was not adjusted in accordance with the temperature greatly differ from the three solid lines (two solid lines representing the case in which the control command was adjusted in accordance with the temperature and the solid line representing the case in which the temperature of the electric rheological fluid 7 was 20° C.) particularly for pitch behaviors (pitch behaviors represented by the broken lines in the cases in which the control was not adjusted in accordance with the temperature greatly change). In contrast, the two solid lines representing the case in which the control command was adjusted in accordance with the temperature have small differences than the broken lines representing the case in which the control command was not adjusted in accordance with the temperature (less differ from the solid line at 20° C.). Therefore, also in this respect, the performance difference caused by the temperature change can be decreased by adjusting the control command in accordance with the temperature.

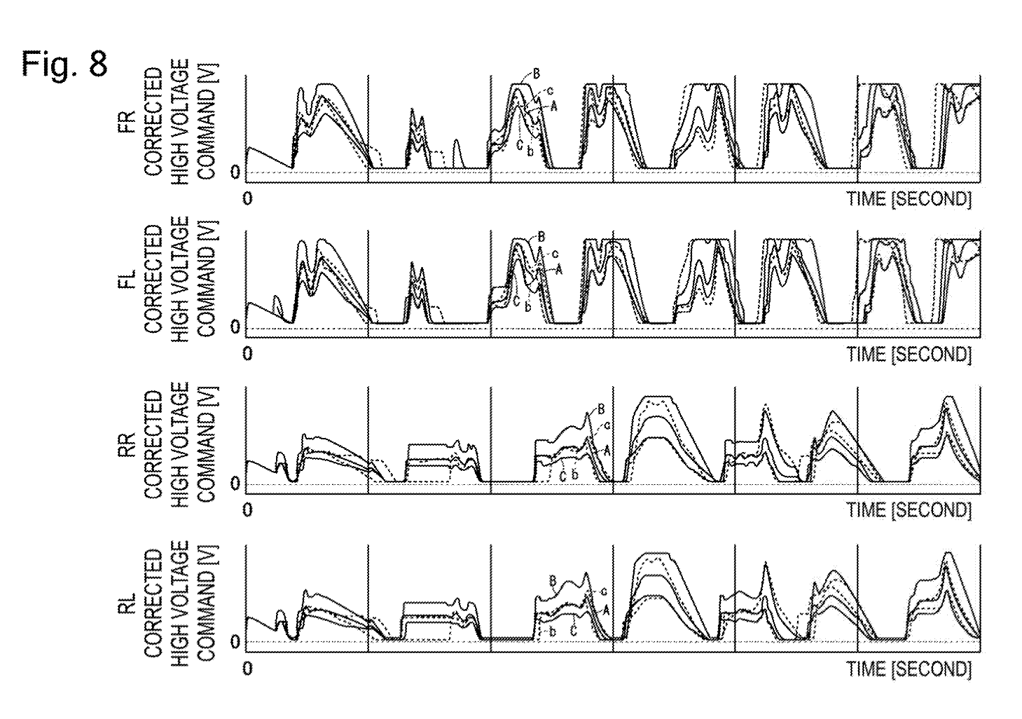

FIG. 8 is diagrams for showing temporal changes (time series data) in the voltage command of the embodiment in which the control command (high voltage command) was adjusted in accordance with the temperature, and a comparative example, in which the control command was not adjusted. Also in FIG. 8, as in FIG. 6 and FIG. 7, three solid lines represent the reference case in which the temperature of the electric rheological fluid 7 was 20° C., the case in which the control command was adjusted in accordance with the temperature when the temperature of the electric rheological fluid 7 was 80° C., and the case in which the control command was adjusted in accordance with the temperature when the temperature of the electric rheological fluid 7 was −20° C., and two broken lines represent the case in which the control command was not adjusted when the temperature of the electric rheological fluid 7 was 80° C. and the case in which the control command was not adjusted when the temperature of the electric rheological fluid 7 was −20° C. In FIG. 8, the case of 20° C., the case with the adjustment at 80° C., the case without the adjustment at 80° C., the case with the adjustment at −20° C., and the case without the adjustment at −20° C. are indicated by “A”, “B”, “b”, “C”, and, “c”, respectively.

As can be found from FIG. 8, while the two broken lines (b and c) representing the case in winch the control command was not adjusted in accordance with the temperature have small differences (the commands do not change) from the solid line (A) in the reference case in which the temperature of the electric rheological fluid 7 was 20° C., the two solid lines (B and C) in which the control command was adjusted in accordance with the temperature have large differences (the commands greatly change) from the solid line (A) in the reference case in which the temperature of the electric rheological fluid 7 was 20° C. In this case, when the temperature of the electric rheological fluid 7 is 80° C., the viscosity decreases for the same corrected high voltage command value, and the damping force thus decreases. Therefore, a damping command corresponding to the solid line (B) representing the case in which the control command was adjusted in accordance with the temperature is larger (the corrected high voltage command value is larger) than that corresponding to the solid line (A) representing the reference case in which the temperature of the electric rheological fluid 7 was 20° C.

Meanwhile, when the temperature of the electric rheological fluid 7 is −20° C., the viscosity increases and decreases for the same corrected high voltage command value, and the damping force thus increases. Therefore, a damping command corresponding to the solid line (C) representing the case in which the control command was adjusted in accordance with the temperature is smaller (the corrected high voltage command value is smaller) than that corresponding to the solid line (A) representing the reference case in which the temperature of the electric rheological fluid 7 was 20° C. From the simulation results of FIG. 6 to FIG. 8, it can be verified that in the embodiment, which adjusts the control command in accordance with the temperature, the performance change caused by the temperature change can be suppressed to the minimum.

In this way, in the embodiment, the change (characteristic change in shock absorber 6) in damping force characteristic caused by the temperature change in electric rheological fluid 7 can be suppressed.

In other words, the command map section 27 and the responsiveness compensation section 28 of the controller 21 correct the command (target voltage value) of the voltage applied to the electric rheological fluid 7 based on the battery current monitor value (more specifically, the resistance value calculated based on the battery current monitor value, consequently, the temperature of the electric rheological fluid 7 calculated from the resistance value). Therefore, the change in damping force characteristic caused by the temperature change in electric rheological fluid 7 can be suppressed through the correction based on the battery current monitor value (the resistance value and the temperature, which are the functions thereof). In other words, the stable performance can be achieved over a range of from a low temperature to a high temperature by switching (changing) the control in accordance with the temperature of the electric rheological fluid 7. As a result, ride comfort and operation stability of the vehicle can be increased regardless of the temperature of the electric rheological fluid 7 (whether the temperature is high or low).

Moreover, the command map section 27 and the responsiveness compensation section 28 of the controller 21 correct the command for the voltage applied to the electric rheological fluid so that the damping force actually generated by the electric rheological fluid 7 approaches the reference damping force generated at the reference temperature (for example, 20° C.) of the electric rheological fluid 7. Therefore, the damping force generated by the electric rheological fluid 7 can be brought to be close to the reference damping force generated at the reference temperature regardless of the temperature of the electric rheological fluid 7 (whether the temperature is high or low). As a result, also in this respect, the ride comfort and the operation stability of the vehicle can be increased.

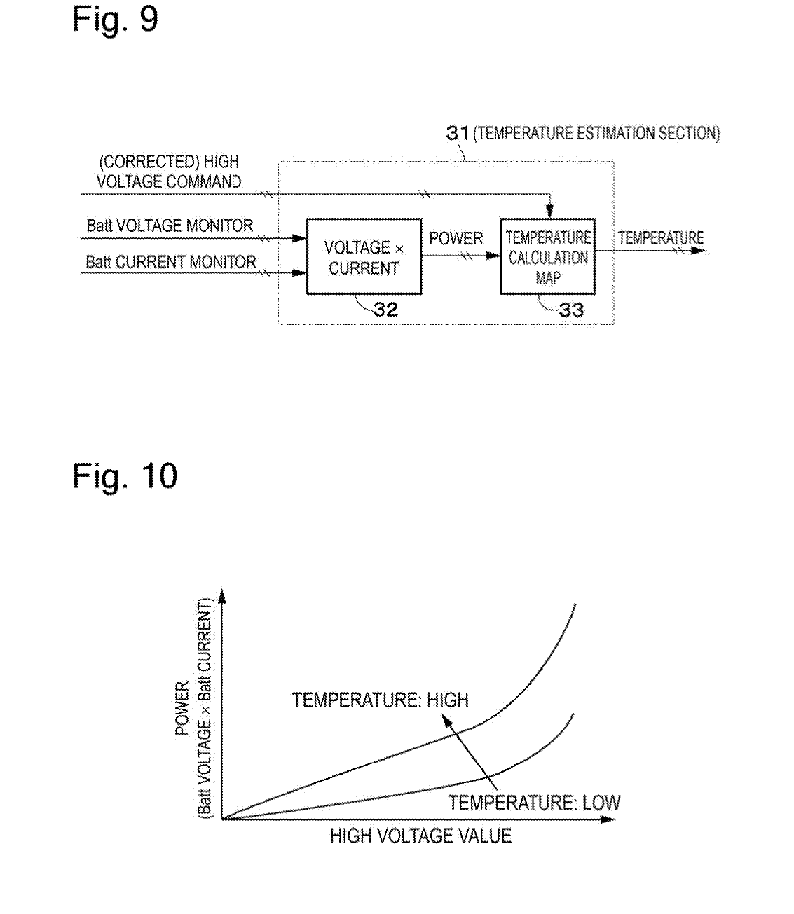

FIG. 9 and FIG. 10 are a diagram and a graph for illustrating a second embodiment. A feature of the second embodiment resides in that the temperature of the electric rheological fluid is estimated (calculated) based on a relationship between power and the temperature of the electric rheological fluid. In the second embodiment, the same components as those of the first embodiment described above are denoted by the same reference symbols, and a description thereof is omitted.

In FIG. 9, a temperature estimation section 31 is used in the second embodiment in place of the temperature estimation section 24 in the first embodiment. Similarly to the temperature estimation section 24 in the first embodiment, the temperature estimation section 31 calculates (estimates) the temperature of the electric rheological fluid 7 based on the battery voltage monitor value, the battery current monitor value, and the corrected high voltage command value, and outputs the temperature (estimated temperature) to the command map section 27 (and the responsiveness compensation section 28).

The temperature estimation section 31 includes a power calculation section 32 and a temperature calculation map section 33. The power calculation section 32 calculates the power by multiplying the battery voltage monitor value and the battery current monitor value output from the high voltage driver 9 by each other. The power calculated by the power calculation section 32 is output to the temperature calculation map section 33.

The temperature calculation map section 33 estimates the temperature of the electric rheological fluid 7 from the power calculated by the power calculation section 32 and the corrected high voltage command value output from the responsiveness compensation section 28 based on, for example, a temperature calculation map shown in FIG. 10. When the responsiveness compensation section 28 is omitted, the high voltage command value output from the command map section 27 may be used in place of the corrected high voltage command value. In the temperature calculation map section 33, a high voltage value of the temperature calculation map of FIG. 10 is set to the corrected high voltage command value or the high voltage command value, to thereby estimate the temperature of the electric rheological fluid 7.

A relationship (characteristic) between the “power”, the “temperature”, and the “high voltage value”, which is obtained in advance through experiments, simulation, or the like, is set (stored) in the temperature calculation map section 33 as, for example, the temperature calculation map of FIG. 10. The reason for the use of the high voltage value is to consider an increase in power in accordance with a change in high voltage value. As shown in FIG. 10, the power of the electric rheological fluid 7 changes in accordance with the high voltage value and the temperature, and the temperature of the electric rheological fluid 7 is thus calculated based on this relationship.

The temperature calculation map section 33 uses the temperature calculation map shown in FIG. 10 to calculate (estimate) the temperature of the electric rheological fluid 7 from the power and the high voltage value (the corrected high voltage command value or the high voltage command value) at the moment. The temperature calculated by the temperature calculation map section 33 is output to the command map section 27 and the responsiveness compensation section 28. In the second embodiment, the map corresponding to the relationship (characteristic) between the power, the temperature, and the high voltage value is used to estimate (calculate) the temperature, but the representation of the relationship is not limited to the map. For example, a calculation expression (function) or an array corresponding to the relationship between the power, the temperature, and the high voltage value may be used.

Moreover, in the second embodiment, as the high voltage value used to estimate the temperature, the command value (the corrected high voltage command value, or the high voltage command value when the responsiveness compensation section 28 is omitted) for the high voltage, which is output from the controller 21 to the high voltage driver 9, is used, but the actual high voltage value may be used in place of the command value. Specifically, the high voltage of the high voltage output line 12 may be monitored, and a monitor signal (high voltage monitor value or high voltage value) of the high voltage may be input to (the temperature calculation map section 33 of) the controller 21.

In the second embodiment, the temperature estimation section 31 is used to calculate the temperature of the electric rheological fluid 7 as described above, and hence a basic action is not particularly different from that of the first embodiment.

In other words, also in the second embodiment, the power (current and voltage) required when the voltage is applied is measured, to thereby estimate the temperature of the electric rheological fluid 7. More specifically, in the second embodiment, the voltage value and the current value used to generate the high voltage applied to the electric rheological fluid 7 are measured (monitored), and the power is calculated from the voltage value and the current value. Then, the temperature of the electric rheological fluid 7 is estimated from the calculated power and the relationship between the temperature and the power measured in advance in accordance with the temperature. In this case, the temperature of the electric rheological fluid 7 may be estimated through the state estimation that is carried out in consideration of the heat generation and the heat radiation (external temperature, water temperature, and vehicle speed) of the shock absorber 6. In any of the cases, the change in damping force characteristic (characteristic change in shock absorber 6) caused by the temperature change in electric rheological fluid 7 can be suppressed as in the first embodiment.

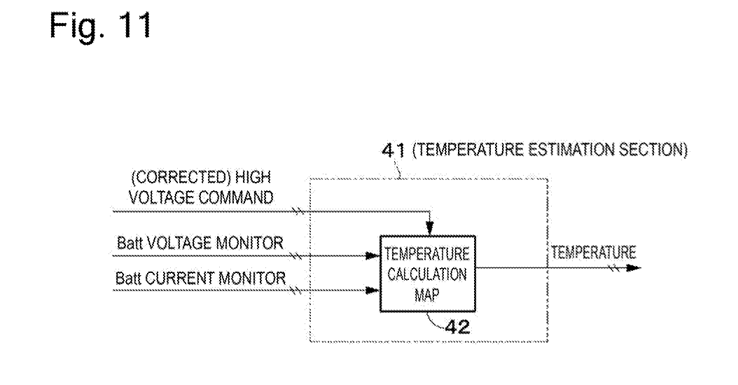

Next, FIG. 11 is a diagram for illustrating a third embodiment. A feature of the third embodiment resides in that the temperature of the electric rheological fluid is estimated (calculated) directly from the current and the voltage (without obtaining the resistance or the power). In the third embodiment, the same components as those of the first embodiment described above are denoted by the same reference symbols, and a description thereof is omitted.

In FIG. 11, a temperature estimation section 41 is used in the third embodiment in place of the temperature estimation section 24 in the first embodiment. Similarly to the temperature estimation section 24 in the first embodiment, the temperature estimation section 41 calculates (estimates) the temperature of the electric rheological fluid 7 based on the battery voltage monitor value, the battery current monitor value, and the corrected high voltage command value, and outputs the temperature (estimated temperature) to the command map section 27 (and the responsiveness compensation section 28).

The temperature estimation section 41 includes a temperature calculation map section 42. The temperature calculation map section 42 estimates the temperature of the electric rheological fluid 7 from the battery voltage monitor value and the battery current monitor value which are output from the high voltage driver 9 and the corrected high voltage command value output from the responsiveness compensation section 28. When the responsiveness compensation section 28 is omitted, the high voltage command value output from the command map section 27 may be used in place of the corrected high voltage command value.

A relationship (characteristic) between the “voltage”, the “current”, “the “temperature”, and the “high voltage value”, which is obtained in advance through experiments, simulation, or the like, is set (stored) in the temperature calculation map section 42 as, for example, a temperature calculation map. The temperature calculation map section 42 uses this temperature calculation map to calculate (estimate) the temperature of the electric rheological fluid 7 from the voltage (battery voltage monitor value), the current (battery current monitor value), and the high voltage value (corrected high voltage command value or high voltage command value) at the moment. The temperature estimation section 41 in the third embodiment is different from the temperature estimation sections 24 and 31 in the first embodiment and the second embodiment in that the temperature is directly calculated without calculating the resistance value or the power in the process of the calculation of the temperature. The other configuration of the temperature estimation section 41 is the same as that of the temperature estimation sections 24 and 31, and a further description is thus omitted.

In the third embodiment, the temperature estimation section 41 is used to calculate the temperature of the electric rheological fluid 7 as described above, and hence a basic action is not particularly different from that of the first embodiment. In other words, also in the third embodiment, the change in damping force characteristic (characteristic change in shock absorber 6) caused by the temperature change in electric rheological fluid 7 can be suppressed as in the first embodiment and the second embodiment.

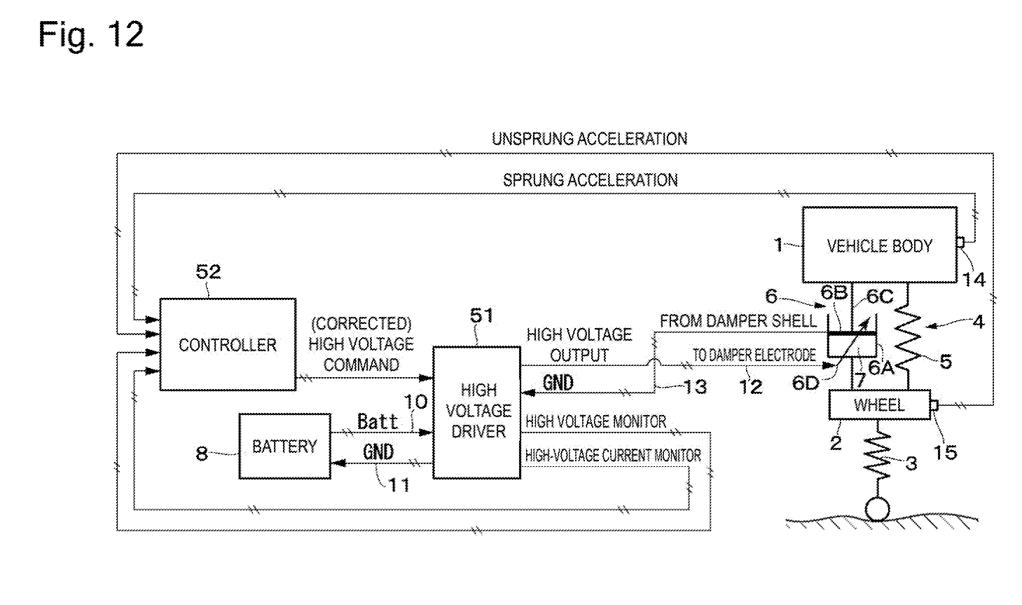

Next, FIG. 12 to FIG. 15 are diagrams for illustrating a fourth embodiment. A feature of the fourth embodiment resides in that the high voltage monitor signal (high voltage monitor value or high voltage value) and a high-voltage current monitor signal (high-voltage current monitor value or high-voltage current value) are used to estimate (calculate) the temperature of the electric rheological fluid. In the fourth embodiment, the same components as those of the first embodiment described above are denoted by the same reference symbols, and a description thereof is omitted.

In FIG. 12, a high voltage driver 51 and a controller 52 are used in the fourth embodiment in place of the high voltage driver 9 and the controller 21 in the first embodiment. The high voltage driver 51 boosts the DC voltage output from the battery 8, based on the commands (high voltage command and corrected high voltage command) output from the controller 52, and supplies (outputs) the boosted DC voltage to the shock absorber 6 similarly to the high voltage driver 9 in the first embodiment.

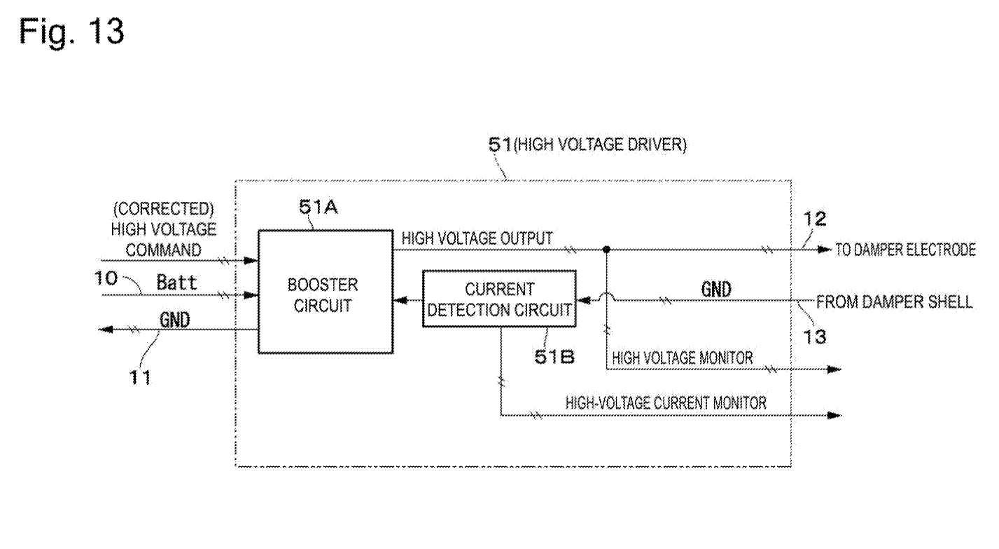

As illustrated in FIG. 13, the high voltage driver 51 includes a booster circuit 51A configured to boost the DC voltage of the battery 8 and a current detection circuit 51B configured to detect a high-voltage current. The booster circuit 51A is the same as the booster circuit 9A in the first embodiment. The current detection circuit 51B is provided between the booster circuit 51A and the shock absorber 6 (on the ground line 13 side), and outputs the high-voltage current monitor signal.

The current detection circuit 51B detects a current value after being boosted by the booster circuit 51A, and outputs a high-voltage current monitor signal, winch is the current value thereof, as the high-voltage current monitor value (high-voltage current value) to (a temperature estimation section 53 of) the controller 52. In the fourth embodiment, with this configuration, the controller 52 constructs the current detection unit. Further, the high voltage driver 51 monitors the high voltage supplied to the shock absorber 6, and outputs to the controller 21 a monitor signal of this high voltage as the high voltage monitor value (high voltage value). In the fourth embodiment, the controller 52 is configured to use the monitor signals of the high voltage system (for example, 5 kV) on the shock absorber 6 side to carry out temperature estimation and control described later.

Meanwhile, similarly to the controller 21 in the first embodiment, the controller 52 is constructed of, for example, a microcomputer, and carries out control of adjusting the damping force of the shock absorber 6 based on the detection results obtained by the sprung acceleration sensor 14 and the unsprung acceleration sensor 15. The controller 52 receives the input of the high voltage monitor signal and the high-voltage current monitor signal which are output from the high voltage driver 51, in addition to the sprung acceleration signal output from the sprung acceleration sensor 14 and the unsprung acceleration signal output from the unsprung acceleration sensor 15. The high voltage monitor signal is a signal representing the high voltage value applied to the high voltage driver 51. The high-voltage current monitor signal is a signal representing the monitored high-voltage current consumed by the high voltage driver 51.

The controller 52 calculates the (corrected) high voltage command corresponding to the force (damping force) to be output in the shock absorber 6, based on the sprung acceleration signal and the unsprung acceleration signal which serve as the behavior information (vehicle behavior signal) on the vehicle, and on the high voltage monitor signal and the high-voltage current monitor signal which serve as the power information (shock absorber power signal) on the shock absorber 6, and outputs the calculated (corrected) high voltage command to the high voltage driver 51.

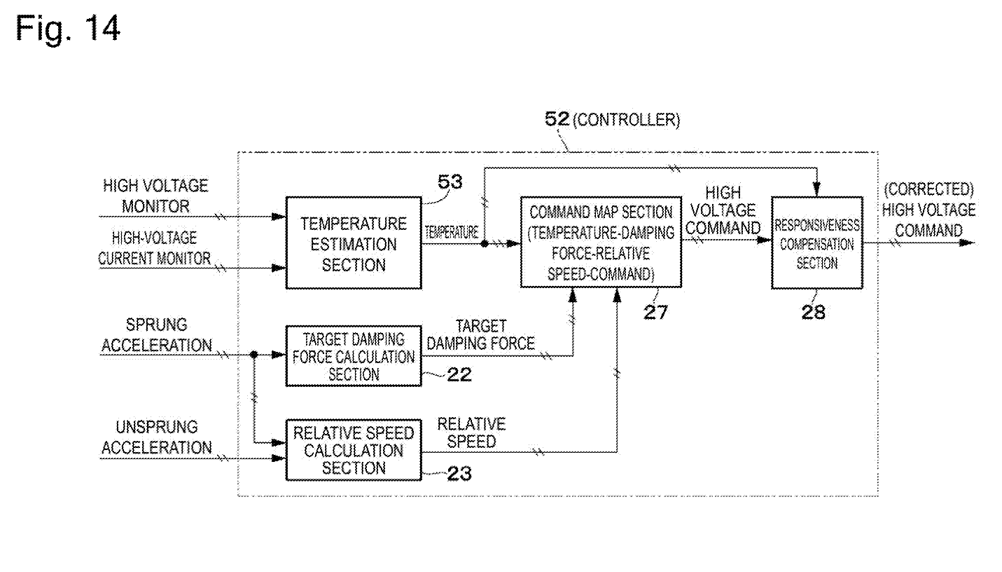

As illustrated in FIG. 14, the controller 52 includes the target damping force calculation section 22, the relative speed calculation section 23, the temperature estimation section 53, the command map section 27, and the responsiveness compensation section 28. The target damping force calculation season 22, the relative speed calculation season 23, the command map section 27, and the responsiveness compensation season 28 are the same as those of the first embodiment.

The temperature estimation section 53 calculates (estimates) the temperature of the electric rheological fluid 7. In this case, the high voltage monitor signal and the high-voltage current monitor signal output from the high voltage driver 9 are input to the temperature estimation section 53. The temperature estimation section 53 calculates (estimates) the temperature of the electric rheological fluid 7 based on the high voltage monitor signal (namely, high voltage monitor value) and the high-voltage current monitor signal (namely, high-voltage current monitor value), and outputs the temperature (estimated temperature) to the command map section 27 (and the responsiveness compensation section 28).

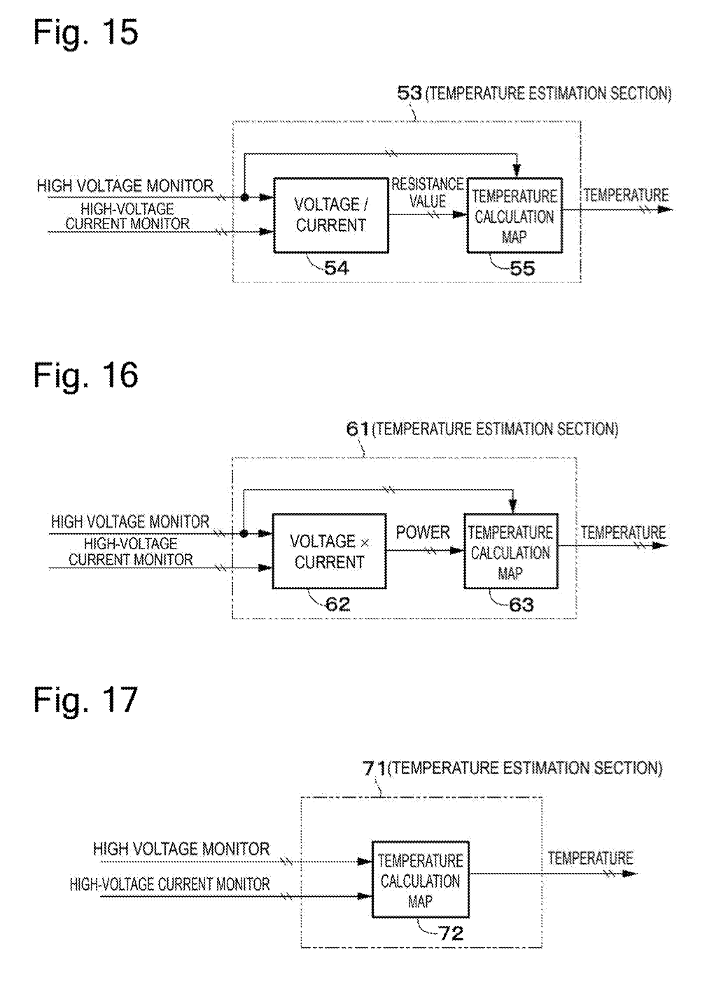

As illustrated in FIG. 15, the temperature estimation section 53 includes a resistance value calculation section 54 and a temperature calculation map section 55. The resistance value calculation section 54 calculates the resistance value of the electric rheological fluid 7 based on the high voltage monitor value and the high-voltage current monitor value which are output from the high voltage driver 9. Specifically, the resistance value of the electric rheological fluid 7 is calculated by dividing the high voltage monitor value by the high-voltage current monitor value. The resistance value calculated by the resistance value calculation section 54 is output to the temperature calculation map section 55.

The temperature calculation map section 55 estimates the temperature of the electric rheological fluid 7 from the resistance value of the electric rheological fluid 7 calculated by the resistance value calculation section 54 and the high voltage monitor value output from the high voltage driver 9, based on, for example, a map similar to the above-mentioned temperature calculation map shown in FIG. 5. In other words, a relationship (characteristic) between the “resistance value” of the electric rheological fluid 7, the “temperature”, and the applied “high voltage value”, which is obtained in advance through experiments, simulation, or the like, is set (stored) in the temperature calculation map section 55 as the map.

The temperature calculation map section 55 uses the temperature calculation map to calculate (estimate) the temperature of the electric rheological fluid 7 from the resistance value and the high voltage value (high voltage monitor value) at the moment. The temperature calculated by the temperature calculation map section 55 is output to the command map section 27 and the responsiveness compensation section 28. In the fourth embodiment, the actual high voltage value, namely, the high voltage monitor value, is used as the high voltage value used to estimate the temperature, namely, the high voltage value applied to the electric rheological fluid 7. Therefore, as compared with the case in which the command value (the corrected high voltage command value or the high voltage command value when the responsiveness compensation section 28 is omitted) for the high voltage, which is output from the controller 21 to the high voltage driver 9, is used, the difference from the actual high voltage value can be suppressed.

As described above, in the fourth embodiment, the high voltage driver 51 and the controller 52 are used to adjust the damping force of the shock absorber 6, and hence a basic action thereof is not particularly different from that of the first embodiment. In other words, also in the fourth embodiment, the change in damping force characteristic (characteristic change in shock absorber 6) caused by the temperature change in electric rheological fluid 7 can be suppressed as in the first embodiment.

Next, FIG. 16 is a diagram for illustrating a fifth embodiment of. A feature of the fifth embodiment resides in that, similarly to the fourth embodiment, the high voltage monitor signal (high voltage monitor value or high voltage value) and the high-voltage current monitor signal (high-voltage current monitor value or high-voltage current value) are used to estimate (calculate) the temperature of the electric rheological fluid. In addition, another feature of the fifth embodiment resides in that the temperature of the electric rheological fluid is estimated (calculated) based on a relationship between the power and the temperature of the electric rheological fluid. In the fifth embodiment, the same components as those of the fourth embodiment described above are denoted by the same reference symbols, and a description thereof is omitted.

In FIG. 16, a temperature estimation section 61 is used in the fifth embodiment in place of the temperature estimation section 53 in the fourth embodiment. Similarly to the temperature estimation section 53 in the fourth embodiment, the temperature estimation section 61 calculates (estimates) the temperature of the electric rheological fluid 7 based on the high voltage monitor value and the high-voltage current monitor value, and outputs the temperature (estimated temperature) to the command map section 27 (and the responsiveness compensation section 28).

The temperature estimation section 61 includes a power calculation section 62 and a temperature calculation map section 63. The power calculation section 62 calculates the power by multiplying the high voltage monitor value and the high-voltage current monitor value which are output from the high voltage driver 9 by each other. The power calculated by the power calculation section 62 is output to the temperature calculation map section 63.

The temperature calculation map section 63 estimates the temperature of the electric rheological fluid 7 from the power calculated by the power calculation section 62 and the high voltage monitor value output from the high voltage driver 9, based on, for example, a map similar to the above-mentioned temperature calculation map shown in FIG. 10. In other words, the temperature calculation map section 63 uses this temperature calculation map to calculate (estimate) the temperature of the electric rheological fluid 7 from the power and the high voltage value (the high voltage monitor value) at the moment. The temperature calculated by the temperature calculation map section 63 is output to the command map section 27 and the responsiveness compensation section 28. In the fifth embodiment, the map corresponding to the relationship (characteristic) between the power, the temperature, and the high voltage value is used to estimate (calculate) the temperature, but the representation of the relationship is not limited to the map. For example, a calculation expression (function) or an array corresponding to the relationship between the power, the temperature, and the high voltage value may be used.

Next, FIG. 17 is a diagram for illustrating a sixth embodiment. A feature of the sixth embodiment resides in that, similarly to the fourth embodiment, the high voltage monitor signal (high voltage monitor value or high voltage value) and the high-voltage current monitor signal (high-voltage current monitor value or high-voltage current value) are used to estimate (calculate) the temperature of the electric rheological fluid. In addition, another feature of the sixth embodiment resides in that the temperature of the electric rheological fund is estimated (calculated) directly from the current and the voltage (without obtaining the resistance or the power). In the sixth embodiment, the same components as those of the fourth embodiment described above are denoted by the same reference symbols, and a description thereof is omitted.

In FIG. 17, a temperature estimation section 71 is used in the sixth embodiment in place of the temperature estimation section 53 of the fourth embodiment. Similarly to the temperature estimation section 53 in the fourth embodiment, the temperature estimation section 71 calculates (estimates) the temperature of the electric rheological fluid 7 based on the high voltage monitor value and the high-voltage current monitor value, and outputs the temperature (estimated temperature) to the command map section 27 (and the responsiveness compensation section 28).

The temperature estimation section 71 includes a temperature calculation map section 72. The temperature calculation map section 72 estimates the temperature of the electric rheological fluid 7 from the high voltage monitor value and the high-voltage current monitor value which are output from the high voltage driver 9. For example, a temperature calculation map similar to that of the temperature calculation map section 42 in the third embodiment is set (stored) in the temperature calculation map section 72. The temperature calculation map section 72 uses this temperature calculation map to calculate (estimate) the temperature of the electric rheological fluid 7 from the voltage (high voltage monitor value) and the current (high-voltage current monitor value) at the moment. The temperature estimation section 71 in the sixth embodiment is different from the temperature estimation sections 53 and 61 in the fourth embodiment and the fifth embodiment in that the temperature is directly calculated without calculating the resistance value or the power in the process of the calculation of the temperature. The other configuration of the temperature estimation section 71 is the same as that of the temperature estimation sections 53 and 61, and a further description is thus omitted.

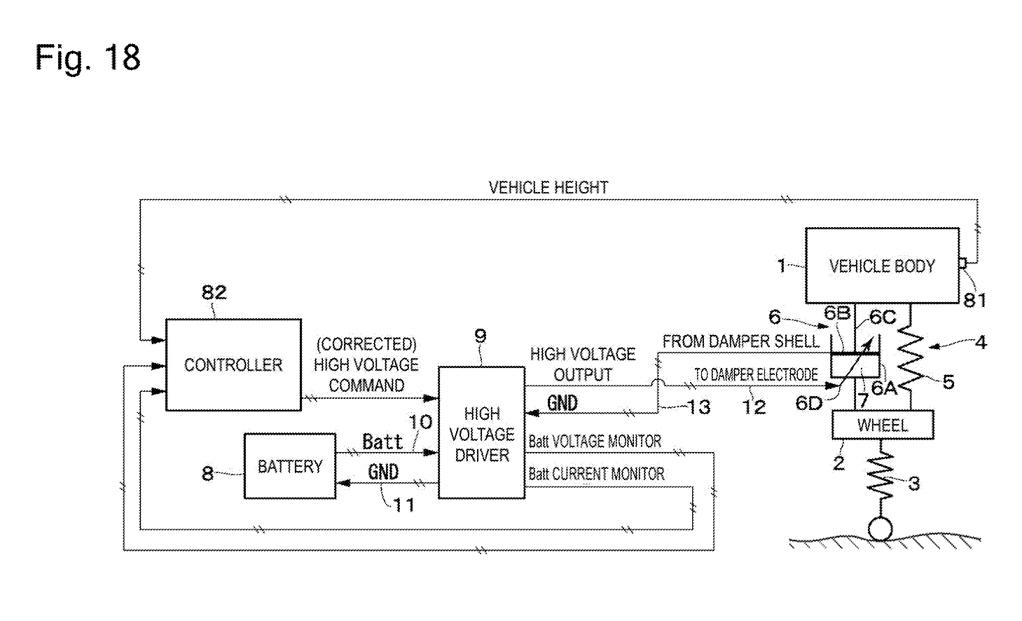

Next, FIG. 18 to FIG. 20 are diagrams for illustrating a seventh embodiment. A feature of the seventh embodiment resides in that a temperature estimation result is used to estimate a vehicle state. In the seventh embodiment, the same components as those of the first embodiment described above are denoted by the same reference symbols, and a description thereof is omitted.

In FIG. 18, a vehicle height sensor 81 is used in the seventh embodiment in place of the sprung acceleration sensor 14 and the unsprung acceleration sensor 15 in the first embodiment. The vehicle height sensor 81 is provided on the vehicle body 1 side, and detects a vehicle height, which is a height of the vehicle body 1 in the vertical direction, and outputs the obtained detection signal to the controller 82. The vehicle height sensor 81 constructs a vehicle behavior detection unit (more specifically, a vertical motion detection unit) configured to detect the behavior of the vehicle (more specifically, the state relating to the motion in the vertical direction of the vehicle).

The controller 82 is used in the seventh embodiment in place of the controller 21 in the first embodiment. The controller 82 is constructed of, for example, a microcomputer similarly to the controller 21 in the first embodiment. The controller 82 carries out control of adjusting the damping force of the shock absorber 6 based on the detection result obtained by fee vehicle height sensor 81. In other words, the controller 21 calculates, based on calculation processing described later, the command to be output to (the booster circuit 9A of) the high voltage driver 9, namely, the (corrected) high voltage command, from the information acquired from the vehicle height sensor 81 to therein control the shock absorber 6, which is the variable-damping-force damper.

More specifically, the controller 82 receives input of the Batt voltage monitor signal and the Batt current monitor signal which are output from the high voltage driver 9, in addition to the vehicle height signal output from the vehicle height sensor 81. The controller 82 calculates the (corrected) high voltage command corresponding to the force (damping force) to be output in the shock absorber 6, based on the vehicle height signal serving as the behavior information (vehicle behavior signal) on the vehicle, and on the Batt voltage monitor signal and the Batt current monitor signal which serve as the power information (shock absorber power signal) on the shock absorber 6, and outputs the calculated (corrected) high voltage command to the high voltage driver 9.

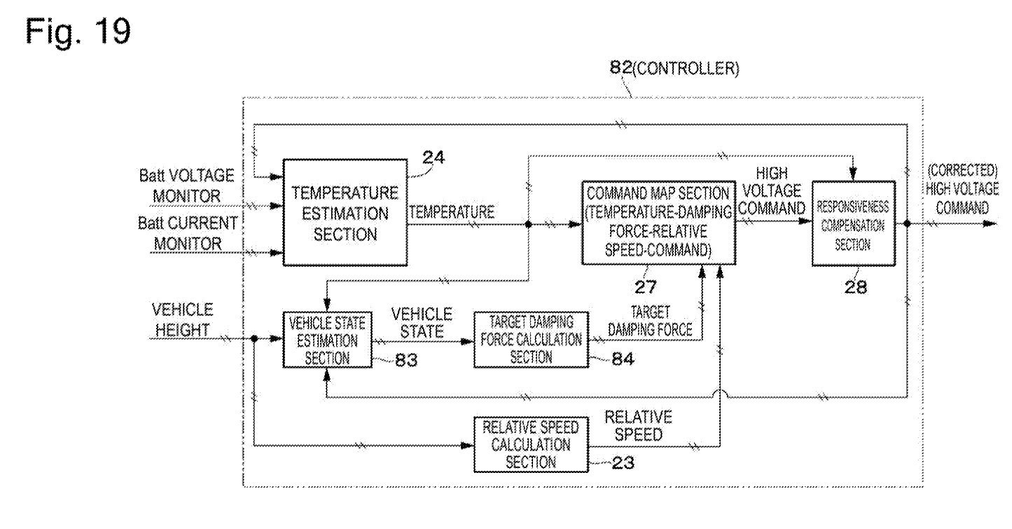

As illustrated in FIG. 19, the controller 82 includes a vehicle state estimation section 83, a target damping force calculation section 84, the relative speed calculation section 23, the temperature estimation section 24, the command map section 27, and the responsiveness compensation section 28. The relative speed calculation section 23, the temperature estimation section 24, the command map section 27, and the responsiveness compensation section 28 are the same as, for example, those of the first embodiment. In the seventh embodiment, the temperature of the electric rheological fluid 7 calculated (estimated) by the temperature estimation section 24 is output not only to the command map section 27 (and the responsiveness compensation section 28) but also to the vehicle state estimation section 83.

The vehicle state estimation section 83 estimates (calculates) the vehicle state at the moment (current time point) based on the detection signal (namely, the vehicle height) from the vehicle height sensor 81, the temperature estimation signal (namely, the temperature) from the temperature estimation section 24, and the corrected high voltage command signal (namely, the corrected high voltage command value). A vehicle state quantity (for example, the sprung speed) calculated by the vehicle state estimation section 83 is output to the target damping force calculation section 84.

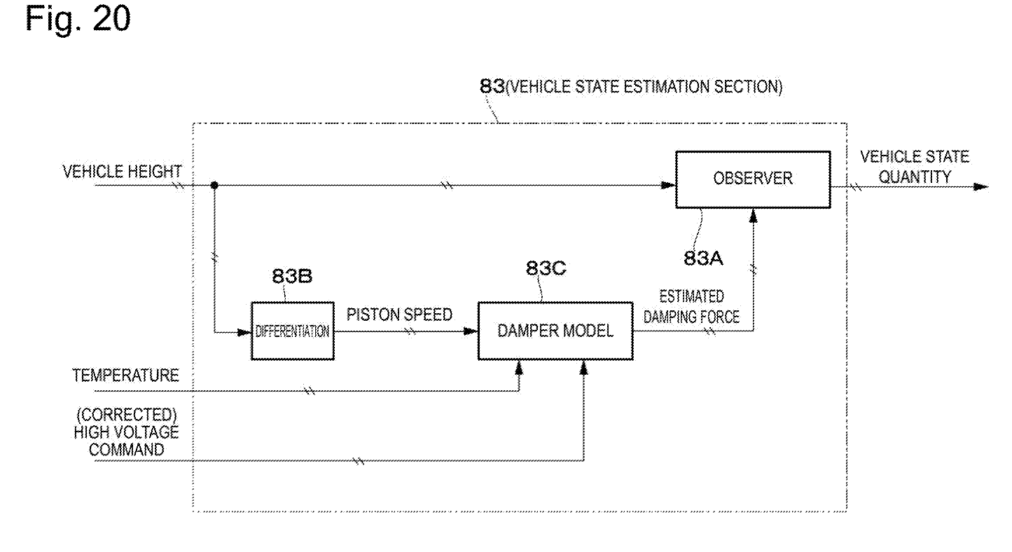

As illustrated in FIG. 20, the chicle state estimation section 83 estimates the vehicle state quantity based on an observer 83A. In this case, the observer 83A is designed so that the damping coefficient is constant. Therefore, in the case of the shock absorber 6 having the electric rheological fluid 7 as the working fluid, the change in damping force caused by the temperature change cannot be considered. Thus, in the seventh embodiment, the change in damping force caused by the temperature change is input to the observer 83A as a disturbance input to the observer 83A, to thereby enable the change in damping force to be considered (reflected).

The vehicle state estimation section 83 considers the change in damping force characteristic of the shock absorber 6 in accordance with the temperature also in the state estimation, and a damper model (shock absorber model) 83C is thus a model in which the temperature characteristic is considered. In other words, the vehicle state estimation section 83 is configured to input the temperature estimation value to the damper model 83C, to thereby consider the damping force change caused by the temperature.

Therefore, the vehicle state estimation section 83 includes the observer 83A, a differentiation section 83B, and the damper model 83C. The observer 83A receives input of the vehicle height from the vehicle height sensor 81 and an estimated damping force from the damper model 83C. The observer 83A outputs the vehicle state quantity (for example, the sprung speed) to the target damping force calculation section 84 based on the vehicle height and the estimated damping force.

The differentiation section 83B receives input of the vehicle height from the vehicle height sensor 81. The differentiation section 83B differentiates the vehicle height, to thereby calculate a piston speed, which is a speed of the piston 6B of the shock absorber 6 (that is, the relative speed in the vertical direction between the vehicle body 1 and the wheel 2). The piston speed calculated by the differentiation section 83B is output to the damper model 83C.

The damper model 83C receives input of the piston speed from the differentiation section 83B, the temperature from the temperature estimation section 24, and the corrected high voltage command value (high voltage command value from the command map section 27 when the responsiveness compensation section 28 is not provided) from the responsiveness compensation section 28. The damper model 83C estimates (calculates) the damping force generated in the shock absorber 6, based on the piston speed, the temperature, and the corrected high voltage command value (high voltage command value), and outputs the estimated damping force to the observer 83A.

In this way, the damper model 83C estimates the damping force generated in the shock absorber 6 additionally in consideration of the temperature of the electric rheological fluid 7. Therefore, even when the temperature of the electric rheological fluid 7 changes, an estimation accuracy of the vehicle state quantity estimated by the observer 83A can be increased. In other words, in a case where the vehicle state quantity is estimated through the model, when the damping force changes, a modeling error occurs, resulting in a decrease in estimation accuracy. In contrast, in the seventh embodiment, the damper model 83C in the estimation model is caused to have the temperature dependency to correct the damping force in accordance with the temperature change, thereby increasing the estimation accuracy.

The target damping force calculation section 84 calculates the target damping force to be generated in the shock absorber 6, based on the vehicle state quantity estimated by the vehicle state estimation section 83, and outputs the calculated target damping force to the command map section 27. In this case, when, for example, the sprung speed is used as the vehicle state quantity from the vehicle state estimation section 83, the target damping force calculation section 84 can calculate the target damping force by multiplying the sprung speed by the skyhook damping coefficient obtained through the skyhook control theory. The control rule for calculating the target damping force is not limited to the skyhook control, and feedback control, for example, the optimal control or H∞ control, can be used.

In the seventh embodiment, the vehicle state estimation section 83 is used to estimate the vehicle state quantity as described above, that is, to estimate the vehicle state quantity additionally in consideration of the damping force change (performance change) caused by the temperature change in electric rheological fluid 7. A basic action thereof is not particularly different from that of the first embodiment.

In particular, in the seventh embodiment, the temperature of the electric rheological fluid 7 is input not only to the command map section 27 but also to the vehicle state estimation section 83 configured to estimate the vehicle state quantity. As a result, the vehicle state estimation section 83 can obtain the vehicle state quantity (estimated damping force) additionally in consideration of the temperature, and the command map section 27 can also obtain the high voltage command additionally in consideration of the temperature. In other words, all the maps, functions, and models relating to the control for the damping force characteristic can have the temperature dependency, to thereby enable the control command to be automatically adjusted in accordance with the damping force change caused by the temperature change. As a result, the change (characteristic change in shock absorber 6) in the damping force characteristic caused by the temperature change in electric rheological fluid 7 can be suppressed.

In the seventh embodiment, a description is given of the case in which the vehicle height and the estimated damping force are input to the observer 83A of the vehicle state estimation section 83 as an example. However, the input is not limited thereto, and various types of information (signals), for example, the vehicle speed, the wheel speed, other than the vehicle height and the estimated damping force may be input to the observer. Moreover, the sprung speed is described as an example of the vehicle state quantity estimated (calculated) by the vehicle state estimation section 83, but the vehicle state quantity is not limited to the sprung speed, and the vehicle state estimation section 83 may be configured to output various state quantities relating to the state of the vehicle, for example, the sprung acceleration.

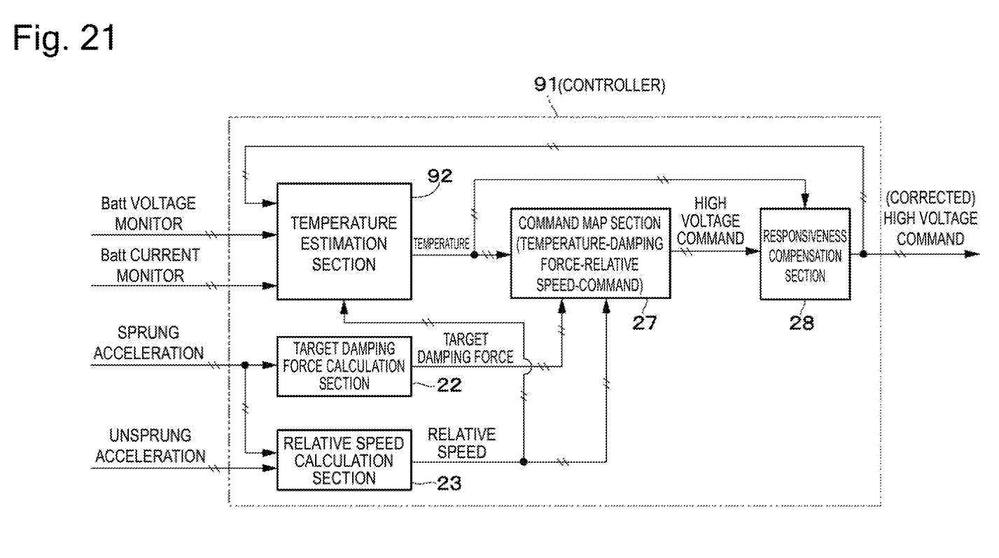

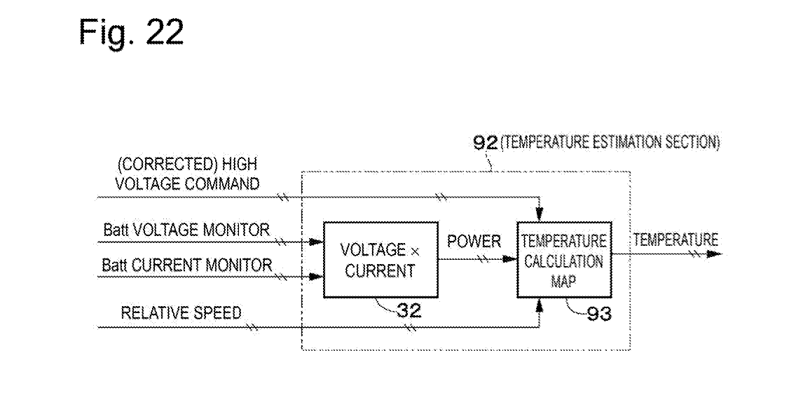

Next, FIG. 21 to FIG. 22 are diagrams for illustrating an eighth embodiment. A feature of the eighth embodiment resides in that the relative speed (piston speed) is used to estimate the temperature. In the eighth embodiment, the same components as those of the first and second embodiments described above are denoted by the same reference symbols, and a description thereof is omitted.

In FIG. 21, a controller 91 is used in the eighth embodiment in place of the controller 21 in the first embodiment. Similarly to the controller 21 in the first embodiment, the controller 91 is constructed of, for example, a microcomputer, and carries out control of adjusting the damping force of the shock absorber 6 based on the defection results obtained by the sprung acceleration sensor 14 and the unsprung acceleration sensor 15.

The controller 91 includes the target damping force calculation section 22, the relative speed calculation section 23, a temperature estimation section 92, the command map section 27, and the responsiveness compensation section 28 similarly to the controller 21 in the first embodiment. The target damping force calculation section 22, the relative speed calculation section 23, the command map section 27, and the responsiveness compensation section 28 are the same as, for example, those of the first embodiment. In the eighth embodiment, the relative speed calculated (estimated) by the relative speed calculation section 23 is output not only to the command map section 27 but also to (a temperature calculation map section 93 of) the temperature estimation section 92.

As illustrated in FIG. 22, the temperature estimation section 92 includes the power calculation section 32 and the temperature calculation map section 93. The power calculation section 32 is, for example, the same as that of the second embodiment (FIG. 9). Meanwhile, the temperature calculation map section 93 is used in the eighth embodiment in place of the temperature calculation map section 33 in the second embodiment.

The temperature calculation map section 93 estimates the temperature of the electric rheological fluid 7 from die power calculated by the power calculation section 32, the corrected high voltage command value output from the responsiveness compensation section 28, and the relative speed (piston speed) calculated by the relative speed calculation section 23.

A relationship (characteristic) between the “power”, the “relative speed”, “the “temperature”, and the “high voltage value”, which is obtained in advance through experiments, simulation, or the like, is set (stored) in the temperature calculation map section 93 as, for example, a temperature calculation map. The temperature calculation map section 93 uses this temperature calculation map to calculate (estimate) the temperature of the electric rheological fluid 7 from the power, the relative speed, and the high voltage value (the corrected high voltage command value or the high voltage command value) at the moment. The temperature calculated by the temperature calculation map section 93 is output to the command map section 27 and the responsiveness compensation section 28. In the eighth embodiment, the map corresponding to the relationship (characteristic) between the power, the relative speed, the temperature, and the high voltage value is used to estimate (calculate) the temperature, but the representation of the relationship is not limited to the map. For example, a calculation expression (function) or an array corresponding to the relationship between the power, the relative speed, the temperature, and the high voltage value may be used.

In the eighth embodiment, the temperature estimation section 92 is used to estimate the temperature as described above, that is, to estimate the temperature additionally in consideration of the relative speed (piston speed), and a basic action thereof is not particularly different from those of the first embodiment and the second embodiment.

In particular, in the eighth embodiment, it is possible to increase the estimation accuracy of the temperature of the electric rheological fluid 7 additionally in consideration of the relative speed (piston speed). In other words, not only the resistance value of the electric rheological fluid 7 changes in accordance with the temperature, but also the temperature (consequently the resistance value) changes in accordance with the relative speed (piston speed). Therefore, in the eighth embodiment, the voltage value and the current value used to generate the high voltage to be applied to the electric rheological fluid 7 are measured (monitored), the power is calculated from the voltage value and the current value, and the temperature of the electric rheological fluid 7 is estimated from the calculated value (power), the relative speed, and the relationship between the temperature and the power, which is measured in advance in accordance with the temperature. In this case, the temperature of the electric rheological fluid 7 may be estimated through the state estimation that is carried out in consideration of the heat generation and the heat radiation (external temperature, water temperature, and vehicle speed) of the shock absorber 6. In any case, the estimation accuracy of the temperature of the electric rheological fluid 7 can be increased by additionally considering the relative speed (piston speed).

In the first embodiment described above, the voltage value correction unit of the controller 21 includes the resistance value calculation section 25 configured to obtain the resistance value of the electric rheological fluid 7 from the detected current value (battery current monitor value) detected by the current detection circuit 9B of the high voltage driver 9, and the temperature calculation map section 26 configured to estimate the temperature of the electric rheological fluid 7 from the resistance value. In other words, in the first embodiment, a description is given of the case in which (the command map section 27 and/or the responsiveness compensation section 28 of) the controller 21 uses the temperature estimated by the temperature calculation map section 26 as the function of the detected current value (battery current monitor value), to thereby correct the target voltage value (to thereby calculate the high voltage command value in the command map section 27 and/or correct the high voltage command value in the responsiveness compensation section 28) as an example.

However, the configuration is not limited to this example, and, for example, the temperature calculation map section 26 may be omitted (may not be provided). In other words, the temperature may not be calculated. That is, as a modification, for example, the voltage value correction unit may include the resistance value calculation section 25 configured to obtain the resistance value of the electric rheological fluid 7 from the detected current value (battery current monitor value) detected by the current detection circuit 9B of the high voltage driver 9, and (the command map section 27 and/or the responsiveness compensation section 28 of) the controller 21 may use the resistance value calculated by the resistance value calculation section 25 as a function of the detected current value (battery current monitor value), to thereby correct the target voltage value (to thereby correct the high voltage command value in the command map section 27 and/or correct the high voltage command value in the responsiveness compensation section 28). Further, in place of the resistance value calculation section 25, the power calculation section 32 may be provided, and the power calculated by the power calculation section 32 may be used as a function of the detected current value to correct the target voltage value.

These points apply to the fourth embodiment. For example, in the fourth embodiment, the temperature calculation map section 55 may be omitted (may not be provided). In other words, the temperature may not be calculated. That is, as a modification, for example, the voltage value correction unit may include the resistance value calculation section 54 configured to obtain the resistance value of the electric rheological fluid 7 from the detected current value (high-voltage current monitor value) detected by the current detection circuit 51B of the high voltage driver 51, and (the command map section 27 and/or the responsiveness compensation section 28 of) the controller 52 may use the resistance value calculated by the resistance value calculation section 54 as a function of the detected current value (high-voltage current monitor value), to thereby correct the target voltage value (to thereby calculate the high voltage command value in the command map section 27 and/or correct the high voltage command value in the responsiveness compensation section 28). Further, in place of the resistance value calculation section 54, the power calculation section 62 may be provided, and the power calculated by the power calculation section 62 may be used as a function of the detected current value to correct the target voltage value.

In the respective embodiments described above, a description is given of the cases in which the voltage correction section (controllers 21 and 52) is configured to estimate the temperature of the electric rheological fluid 7 from the detected current value (battery current monitor value and the high-voltage current monitor value), that is, the cases in which the temperature is used as the function of the detected current value (battery current monitor value and high-voltage current monitor value) to correct the target voltage value as an example. However, the configuration is not limited to those cases, and, for example, as a modification, the target voltage value may be corrected based on the detected current value (battery current monitor value and high-voltage current monitor value) not via the function (resistance, power, or temperature) of the detected current value.

In the first embodiment described above, a description is given of the case in which the shock absorber 6 of the suspension apparatus 4 is mounted to the vehicle, for example, a motor vehicle, in the vertical placement as an example, but the configuration is not limited to this case. For example, the shock absorber may be mounted to a vehicle, for example, a railway vehicle, in a horizontal placement. This applies to the other embodiments (second embodiment to eighth embodiment).

Further, the respective embodiments and the respective modifications are examples, and it should be understood that the configurations of different embodiments and modifications may be partially replaced or combined with each other.

According to the above-mentioned embodiments, the change (the characteristic change in damping force adjustable shock absorber) in the damping force characteristic caused by the temperature change in electric rheological fluid can be suppressed.

In other words, according to the embodiments, the voltage value correction unit is configured to correct the target voltage value based on the detected current value (or the function of the detected current value) exhibited when the target voltage value is applied. The resistance value of the electric rheological fluid changes in accordance with the temperature. Therefore, the change in damping force characteristic caused by the temperature change in electric rheological fluid can be suppressed by correcting the target voltage value based on the current value reflecting the change in resistance value. In other words, the control can be switched (changed) in accordance with the temperature of the electric rheological fluid, and the stable performance can be achieved over a range of from a low temperature to a high temperature. As a result, the ride comfort and the operation stability of the vehicle can be increased regardless of the temperature of the electric rheological fluid (whether the temperature is high or low).

According to the embodiments, the voltage value correction unit is configured to correct the target voltage value so that the damping force actually generated by the electric rheological fluid approaches the reference damping force generated at the reference temperature of the electric rheological fluid. Therefore, the damping force generated by the electric rheological fluid can be brought to be close to the reference damping force generated at the reference temperature regardless of the temperature of the electric rheological fluid (whether the temperature is high or low). As a result, the ride comfort and the operation stability of the vehicle can be increased.

According to the embodiments, the voltage value correction unit includes the resistance value calculation unit configured to obtain the resistance value of the electric rheological fluid from the detected current value detected by the current detection unit, and is configured to use the resistance value calculated by the resistance value calculation unit as the function of the detected current value, to thereby correct the target voltage value. Therefore, the change in damping force characteristic caused by the temperature change in electric rheological fluid can be suppressed by correcting the target voltage value based on the resistance value of the electric rheological fluid.

According to the embodiments, the voltage value correction unit includes the resistance value calculation unit configured to obtain the resistance value of the electric rheological fluid from the detected current value detected by the current detection unit, and the temperature estimation unit configured to estimate the temperature of the electric rheological fluid from the resistance value calculated by the resistance value calculation unit. Further, the voltage value correction unit is configured to use the temperature estimated by the temperature estimation unit as a function of the detected current value, to thereby correct the target voltage value. Therefore, the change in damping force characteristic caused by the temperature change in electric rheological fluid can be suppressed by correcting the target voltage value based on the temperature of the electric rheological fluid.

As a first aspect of the suspension control apparatus, there is provided a suspension control apparatus includes: a vehicle behavior detection unit configured to detect a behavior of a vehicle; a damping force adjustable shock absorber provided between two members of the vehicle which are configured to move relative to each other; and a controller configured to carry out control so as to adjust a damping force of the damping force adjustable shock absorber based on a detection result obtained by the vehicle behavior detection unit. The damping force adjustable shock absorber includes: a cylinder in which electric rheological fluid is encapsulated; a piston slidably inserted into the cylinder; a piston rod coupled to the piston, and extending to an outside of the cylinder; and an electrode provided at a portion through which a flow of the electric rheological fluid is to be generated by a slide motion of the piston in the cylinder, and configured to apply electric field to the electric rheological fluid. The controller includes: a target voltage value setting unit configured to obtain a target voltage value to be applied to the electrode, based on the detection result obtained by the vehicle behavior detection unit; a current detection unit configured to detect a current value exhibited when the target voltage value obtained by the target voltage value setting unit is applied; and a voltage value correction unit configured to correct the target voltage value based on the detected current value detected by the current detection unit or a function of the detected current value.

As a second aspect of the suspension control apparatus, in the above-mentioned first aspect, the voltage value correction unit is configured to correct the target voltage value so that a damping force actually generated by the electric rheological fluid approaches a reference damping force generated at a reference temperature of the electric rheological fluid.

As a third aspect of the suspension control apparatus, in the above-mentioned first and second aspects, the voltage value correction unit includes a resistance value calculation unit configured to obtain a resistance value of the electric rheological fluid from the detected current value detected by the current detection unit, and the voltage value correction unit is configured to use the resistance value calculated by the resistance value calculation unit as the function of the detected current value to correct the target voltage value.

As a fourth aspect of the suspension control apparatus, in the above-mentioned first and second aspects, the voltage value correction unit includes: a resistance value calculation unit configured to obtain a resistance value of the electric rheological fluid from the detected current value detected by the current detection unit, and a temperature estimation unit configured to estimate a temperature of the electric rheological fluid from the resistance value calculated by the resistance value calculation unit, and the voltage value correction unit is configured to use the temperature estimated by the temperature estimation unit as the function of the detected current value to correct the target voltage value.

The embodiments of the present invention have been described above. The embodiments of the present invention described above are intended for easy understanding of the present invention, and do not limit the present invention. It should be understood that the present invention can be changed and modified without departing from the spirit thereof and encompasses equivalents thereof. Further, within a range in which the above-mentioned problems can be at least partially solved or within a range in which the effects are at least partially obtained, a suitable combination or omission of the components recited in the claims and described in the specification is possible.

The present application claims priority to the Japanese Patent Application No. 2015-131460 filed on Jun. 30, 2015. The entire disclosure including the specification, the claims, the drawings, and the abstract of Japanese Patent Application No. 2015-131460 filed on Jun. 30, 2015 is incorporated herein in its entirety by reference.

### REFERENCE SIGNS LIST

1 vehicle body (one of members of vehicle, which are configured to move relative to each other), 2 wheel (another one of members of vehicle, which are configured to move relative to each other), 6 shock absorber (damping force adjustable shock absorber), 6A cylinder, 6B piston, 6C piston rod, 6D electrode, 7 electric rheological fluid, 9, 51 high voltage driver, 9B, 51B current detection circuit (current detection unit), 14 sprung acceleration sensor (vehicle behavior detection unit), 15 unsprung acceleration sensor (vehicle behavior detection unit), 21, 52, 82, 91 controller, 22, 84 target damping force calculation section (target voltage value setting unit), 23 relative speed calculation section (target voltage value setting unit), 24, 31, 41, 53, 61, 71, 92 temperature estimation section (voltage value correction unit), 25, 54 resistance value calculation section (resistance value calculation unit), 26, 33, 42, 55, 63, 72, 93 temperature calculation map section (temperature estimation unit), 27 command map section (target voltage value setting unit, voltage value correction unit), 28 responsiveness compensation section (voltage value correction unit), 81 vehicle height sensor (vehicle behavior detection unit), 83 vehicle state estimation section (target voltage value setting unit, voltage value correction unit)

1-4. (canceled)

5. A suspension control apparatus, comprising:
a vehicle behavior detection unit configured to detect a behavior of a vehicle;
a damping force adjustable shock absorber provided between two members of the vehicle, which are configured to move relative to each other; and
a controller configured to carry out control so as to adjust a damping force of the damping force adjustable shock absorber based on a detection result obtained by the vehicle behavior detection unit, wherein
the damping force adjustable shock absorber includes:
a cylinder in which electric rheological fluid is encapsulated;
a piston slidably inserted into the cylinder;
a piston rod coupled to the piston, and extending to an outside of the cylinder; and
an electrode provided at a portion through which a flow of the electric rheological fluid is to be generated by a slide motion of the piston in the cylinder, and configured to apply electric field to the electric rheological fluid, and
the controller includes:
a target voltage value setting unit configured to obtain a target voltage value to be applied to the electrode, based on the detection result obtained by the vehicle behavior detection unit;
a current detection unit configured to detect a current value exhibited when the target voltage value obtained by the target voltage value setting unit is applied; and
a voltage value correction unit configured to correct the target voltage value based on the detected current value detected by the current detection unit or a function of the detected current value, and a relative speed.

6. The suspension control apparatus according to claim 5, wherein the voltage value correction unit is configured to correct the target voltage value so that a damping force actually generated by the electric rheological fluid approaches a reference damping force generated at a reference temperature of the electric rheological fluid.

7. The suspension control apparatus according to claim 5, wherein
the voltage value correction unit includes a resistance value calculation unit configured to obtain a resistance value of the electric rheological fluid from the detected current value detected by the current detection unit, and
the voltage value correction unit is configured to use the resistance value calculated by the resistance value calculation unit as the function of the detected current value to correct the target voltage value.

8. The suspension control apparatus according to claim 6, wherein
the voltage value correction unit includes a resistance value calculation unit configured to obtain a resistance value of the electric rheological fluid from the detected current value detected by the current detection unit, and
the voltage value correction unit is configured to use the resistance value calculated by the resistance value calculation unit as the function of the detected current value to correct the target voltage value.

9. The suspension control apparatus according to claim 5, wherein
the voltage value correction unit includes:
a resistance value calculation unit configured to obtain a resistance value of the electric rheological fluid from the detected current value detected by the current detection unit; and
a temperature estimation unit configured to estimate a temperature of the electric rheological fluid from the resistance value calculated by the resistance value calculation unit, and
the voltage value correction unit is configured to use the temperature estimated by the temperature estimation unit as the function of the detected current value to correct the target voltage value.

10. The suspension control apparatus according to claim 6, wherein
the voltage value correction unit includes:
a resistance value calculation unit configured to obtain a resistance value of the electric rheological fluid from the detected current value detected by the current detection unit; and
a temperature estimation unit configured to estimate a temperature of the electric rheological fluid from the resistance value calculated by the resistance value calculation unit, and
the voltage value correction unit is configured to use the temperature estimated by the temperature estimation unit as the function of the detected current value to correct the target voltage value.

11. The suspension control apparatus according to claim 5, wherein
the voltage value correction unit includes a temperature estimation unit configured to estimate a temperature of the electric rheological fluid,
the temperature estimation unit is configured to perform a state estimation from a voltage value and the current value obtained by the current detection unit, the relative speed, and a relationship between a temperature and a power measured in advance in accordance with the temperature.
